(19) United States
(12) Patent Application Publication
(10) Pub. No.: US 2021/0109777 A1
(43) Pub. Date: Apr. 15, 2021

(54) SYSTEMS AND METHODS OF COMPUTER SYSTEM MONITORING AND CONTROL

(71) Applicant: ROSS VIDEO LIMITED, Iroquois (CA)

(72) Inventors: David Austin Tubbs, Sandy, UT (US); Garn H. Morrell, Kaysville, UT (US)

(21) Appl. No.: 16/597,355

(22) Filed: Oct. 9, 2019

(51) Int. Cl. G06F 9/48

(52) U.S. Cl. CPC G06F 9/4843

(57) ABSTRACT

An output signal indicative of one or both of a display signal and an audio signal currently being provided as output by a computer system is routed to or otherwise provided to another computer system for analysis. A determination is made as to whether the output signal satisfies one or more conditions for performing one or more actions. The action, or each action in the case of multiple actions, is initiated responsive to a determination that the output signal satisfies the condition(s). Other monitoring and control embodiments are also disclosed, and may be implemented in so-called Keyboard, Video, and Mouse (KVM) systems or non-KVM systems.

### FIELD

The present disclosure relates generally to monitoring computer systems and, in some embodiments, to Keyboard, Video, and Mouse (KVM)-based systems.

### BACKGROUND

In the area of computer system monitoring and control, Simple Network Management Protocol (SNMP) is a technology that is used to provide support for some computer-based applications. SNMP technology provides an Application Programming Interface (API) that is accessible across a computer network, and is capable of indicating some, but certainly not all, of the errors that may affect a computer system. For example, SNMP may indicate power supply difficulties, fan failures, and hard drive instability. However, a significant number of computer-based applications do not provide SNMP support and thus cannot communicate the cause of many critical error types, or even the existence of some errors or conditions affecting computer system operation.

Artificial Intelligence (AI) relates to the simulation of human intelligence processes by machines. Examples of AI applications within computer systems include: expert systems, speech recognition, and machine vision. Processing and recognition capabilities of AI may also hold promise in application to computer system monitoring and control.

In general, improved computer system monitoring and control techniques and implementations may be desirable.

### SUMMARY

AI has the ability to analyze digital video and audio information and recognize patterns or conditions in such information. This ability may be particularly useful in such applications as analyzing computer system video output and/or audio output as disclosed herein, to identify error messages or indications that are displayed on a computer screen or otherwise indicated in a computer system output and might not be detectable using conventional technology such as SNMP, for example.

According to an aspect of the present disclosure, a method involves: receiving, by a first computer system, an output signal indicative of one or both of a display signal and an audio signal currently being provided as output by a second computer system; determining, by the first computer system, whether the output signal satisfies a condition for performing an action; and initiating, by the first computer system and responsive to determining that the output signal satisfies the condition, the action.

In an embodiment, the determining involves determining, based on a set of one or more rules, whether the output signal satisfies a condition for performing an action.

The action may include, for example, one or more of: blocking a control signal that is intended to control the second computer system; blocking an operation of the second computer system; and aborting an operation of the second computer system.

The action may also or instead involve providing a control signal to the second computer system. The action may then further include blocking a further control signal that is intended to control the second computer system. The further control signal may be or include a control signal generated by the second computer system, and/or a control signal generated by a third computer system by which the second computer system is controllable.

Another example of an action is generating an alert. The alert may be or include an alert to one or more of: the first computer system, the second computer system, a further computer system, and an alert device.

The second computer system may be part of a KVM system, in which case the receiving may involve receiving the output signal from a management component of the KVM system.

In some embodiments, the second computer system is or includes a virtual machine.

An apparatus, according to another aspect of the present disclosure, includes: a communication interface; and an analysis subsystem, coupled to the communication interface, to receive through the communication interface an output signal indicative of one or both of a display signal and an audio signal currently being provided as output by a computer system, to determine whether the output signal satisfies a condition for performing an action, and to initiate the action responsive to determining that the output signal satisfies the condition.

The analysis subsystem is to determine, based on a set of one or more rules, whether the output signal satisfies a condition for performing an action in some embodiments.

The action may include, for example, one or more of: blocking a control signal that is intended to control the computer system; blocking an operation of the computer system; and aborting an operation of the computer system.

The action may also or instead involve providing a control signal to the computer system. The action may then further include blocking a further control signal that is intended to control the computer system. The further control signal may be or include a control signal generated by the computer system, and/or a control signal generated by a further computer system by which the computer system is controllable.

Another example of an action is generating an alert. The alert may be or include an alert to one or more of: the apparatus; the computer system, a further computer system, and an alert device.

The computer system may be part of a KVM system, in which case the communication interface may enable communication between the apparatus and a management component of the KVM system, and the analysis subsystem is coupled to the communication interface to receive the output signal from the management component.

In some embodiments, the computer system is or includes a virtual machine.

Another aspect of the present disclosure relates to a non-transitory processor-readable medium storing instructions which, when executed by a processor in a first computer system cause the processor to perform a method. The method involves: receiving, by the first computer system, an output signal indicative of one or both of a display signal and an audio signal currently being provided as output by a second computer system; determining, by the first computer system, whether the output signal satisfies a condition for performing an action; and initiating, by the first computer system and responsive to determining that the output signal satisfies the condition, the action.

A method according to yet another aspect of the present disclosure involves: routing, between a first computer system and a second computer system, an output signal indicative of one or both of a display signal and an audio signal currently being provided as output by the second computer system; and further routing the output signal to an analysis system for determination as to whether the output signal satisfies a condition for performing an action and initiation of the action responsive to a determination that the output signal satisfies the condition.

In some embodiments, the method also involves: receiving from the analysis system a signal associated with initiating the action; and routing the signal associated with initiating the action to one or both of the first computer system and the second computer system.

A further aspect of the present disclosure provides an apparatus that includes: a communication interface; and a signal handler, coupled to the communication interface, to route, between a first computer system and a second computer system, an output signal indicative of one or both of a display signal and an audio signal currently being provided as output by the second computer system, and to further route the output signal to an analysis system for determination as to whether the output signal satisfies a condition for performing an action and initiation of the action responsive to a determination that the output signal satisfies the condition.

A non-transitory processor-readable medium is also provided, and stores instructions which, when executed by a processor cause the processor to perform a method that involves: routing, between a first computer system and a second computer system, an output signal indicative of one or both of a display signal and an audio signal currently being provided as output by the second computer system; and further routing the output signal to an analysis system for determination as to whether the output signal satisfies a condition for performing an action and initiation of the action responsive to a determination that the output signal satisfies the condition.

Other aspects and features of embodiments of the present disclosure will become apparent to those ordinarily skilled in the art upon review of the following description.

### BRIEF DESCRIPTION OF THE DRAWINGS

Examples of embodiments of the invention will now be described in greater detail with reference to the accompanying drawings.

FIG. 1 is a block diagram of an example KVM extender system to support the implementation of a user station remotely from a computer resource.

FIG. 2 is a block diagram of an example KVM matrix to support simultaneous remote access to multiple computer resources by multiple user stations.

FIG. 3 is a block diagram of another example KVM matrix, with the addition of an Artificial Intelligence Recognition and Control System (AI-RCS).

FIG. 4 is a block diagram of a further example KVM matrix, with the addition of a cloud-based AI-RCS.

FIG. 5 is a block diagram of an embodiment of an AI-RCS interface shared among several user stations.

FIG. 6 is a block diagram illustrating a system in which an AI-RCS is implemented in conjunction with several user stations.

FIG. 7A is a diagram illustrating data flows within an example AI-RCS pipeline.

FIG. 7B is a diagram that includes part of the example AI-RCS pipeline of FIG. 7A, with particular focus on a recognition phase and associated processes.

FIG. 7C is a diagram that includes part of the example AI-RCS pipeline of FIG. 7A, with particular focus on a control phase and associated processes.

FIG. 8 is a flow diagram illustrating operation of a difference processing (“diff-proc”) interface according to an embodiment.

FIG. 9 is a block diagram illustrating an example of comparison of video frames according to an embodiment of difference processing.

FIG. 10 is a block diagram illustrating an example of a target container and its contents according to an embodiment.

FIG. 11 is a flow diagram illustrating an example method according to an embodiment.

FIG. 12 is a block diagram illustrating an apparatus according to another embodiment.

FIG. 13 is a block diagram illustrating an apparatus according to a further embodiment.

### DETAILED DESCRIPTION

Example embodiments are discussed in detail herein. It should be appreciated, however, that the present disclosure provides concepts that can be embodied in any of a wide variety of specific contexts. The embodiments discussed are merely illustrative, and do not limit the scope of the present disclosure.

A computer resource may be located remotely from a user or an operator, in a so-called KVM system for example. In a KVM system, a user station or operator station is a relatively “dumb” computer system terminal, including one or more user Input/Output (I/O) devices and one or more communication interfaces, as described in further detail by way of example elsewhere herein. In some embodiments, Internet Protocol (IP) computer network connections are used to implement a KVM-Over-IP communication path.

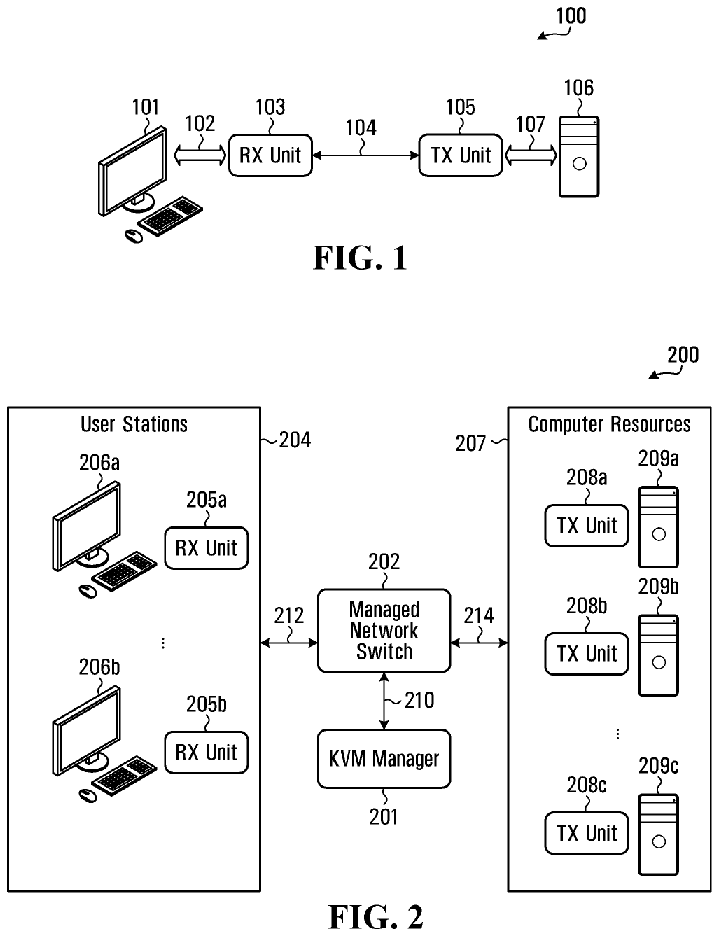

FIG. 1 is a block diagram of an example KVM extender system to support the implementation of a user station remotely from a computer resource, such as in a separate room or building. In the example system 100, user station 101 is coupled to a receive (RX) unit 103 through a connection 102. RX unit 103 is also coupled to a transmit (TX) unit 105 through a connection 104, and the TX unit 105 is coupled to a computer resource 106 by a connection 107.

In a KVM system, a user station 101 includes three primary components, namely a keyboard, a video screen, and a mouse, various examples of which will be familiar to those skilled in the art. These are examples of I/O devices that may be provided at the user station 101, and others may also or instead be provided. For instance, the user station 101 may include an I/O device such as a touchscreen to provide multiple I/O features in one I/O device.

A communication interface at the user station 101 is coupled to at least the user station I/O component(s) in order to enable the user station to communicate with the remote computer resource 106, and thereby enable the computer resource to be monitored and/or operated from the user station. The communication interface at the user station 101 provides a connectivity path not only for video, but also or instead for audio associated with video in some KVM solutions.

In general, a communication interface includes some sort of physical component such as a physical port or connector, and may also include one or more other components to support communications through that port or connector. The particular structure of a communication interface will be dependent upon such characteristics as the type of connection over which communications are to be supported and/or the communication protocol(s) that are to be supported, for example. In some embodiments, the user station 101 includes one or more video connectors. One or more audio connectors and/or one or more other types of connectors such as Universal Serial Bus (USB) connectors may also or instead be provided in the user station 101.

In a KVM system, the connection 102 typically includes at least a video cable. An audio cable may also or instead be provided. Other types of connections are also possible, including one or more USB cables for example. The present disclosure is not limited to any particular type of connection 102. In general, the connection 102 may be or include one or more wired and/or wireless connections, and compatible interfaces are provided at the user station 101 and the RX unit 103. In some embodiments, an RX unit is integrated into a user station instead of a separate component 103 as shown. In such embodiments, the connection 102 is an internal connection within a user station.

The RX unit 103 includes one or more communication interfaces compatible with the connections 102, 104. The same interface(s) or type(s) of interface may be compatible with both of the connections 102, 104. In other embodiments, different interfaces are provided for one or more connections 102 to the user station 101 and for one or more connections 104 to the TX unit. For example, the connections 102, 104 may be different types of connections. The RX unit 103 may include one or more interfaces of the same type as, or at least compatible with, one or more interfaces at the user station 101, as well as one or more interfaces of the same type as, or at least compatible with, one or more interfaces at the TX unit 105.

The RX unit 103 includes at least a signal handler, which may be implemented using hardware, firmware, components which execute software, or some combination thereof. Electronic devices that might be suitable for this purpose include, among others, microprocessors, microcontrollers, Programmable Logic Devices (PLDs), Field Programmable Gate Arrays (FPGAs), Application Specific Integrated Circuits (ASICs), and other types of “intelligent” integrated circuits. A signal handler is intended to generally refer to a component, or multiple components, to handle transfer of signals through the RX unit 103. Such signals may be transferred from the TX unit 105 to the user station 101 and/or from the user station to the TX unit. The RX unit may include one or more other components such as one or more signal converters, one or more signal translators, one or more signal processors, and/or one or more components configured to perform operations related to communications with the user station 101 and/or the TX unit 105. Implementation options for such components include at least those outlined above for a signal handler. In some embodiments a single processor or other physical device or circuitry is used to implement a signal handler and other components of the RX unit 103.

In the example system 100, the connection 104 is represented differently than the connections 102, 107, to illustrate that different connection types are expected to be implemented between the RX unit 103 and the TX unit 105 than between the RX unit and the user station 101 or between the TX unit and the computer resource 106. For example, as noted elsewhere herein the user station 101 in a KVM system is located remotely from the computer resource 106. In some embodiments, the connections 102, 107 are local or relatively short-range connections, and the connection 104 is a relatively long-range connection intended for communications over a longer distance than connections 102, 107. The connection 104 connects the RX unit 103 and the TX unit 105 via a network, illustratively through an IP connection, in some embodiments. Such a connection may be over copper cabling to support a distance of up to approximately 100m or 300 feet, or optical fiber cabling to support a distance up to approximately 40 km or 25 miles. The present disclosure is not limited to any particular type of connection 104, and in general the connection 104 may be or include one or more wired and/or wireless connections, and compatible interfaces are provided at the RX unit 103 and the TX unit 105.

The TX unit 105 is a counterpart to the RX unit 103, and these units have the same structure or at least similar structures in some embodiments. The TX unit 105 at least has a communication interface that is the same as, or is otherwise compatible with, a communication interface of the RX unit 103, to support communications over the connection 104. The TX unit 105 also includes at least a signal handler and one or more communication interfaces compatible with the connection 107. Other components, such as those noted above for the RX unit 103, may also or instead be provided at the TX unit 105. At least the implementation examples provided above for the RX unit communication interfaces, signal handler, and/or other components also apply to the TX unit 105.

Similarly, the connection 107 may be or include the same type(s) of connection as the connection 102. In some embodiments, the TX unit 105 is part of the computer resource 106, and the connection 107 is an internal connection in the computer resource. It is expected that the RX unit 103 and the TX unit 105 support the same type(s) of connections 102, 107, but this is not necessarily the case in all embodiments.

The computer resource 106 represents a computer system that includes such components as one or more I/O devices, one or more memory devices, and a processor to perform any of various operations. Although the present disclosure is not restricted to implementation in conjunction with any particular type of computer resource, in some embodiments the computer resource 106 is a computer system such as a video server or other component in a video production system. In some embodiments, the computer resource 106 may be a laptop or desktop computer; in other embodiments, the computer resource 106 may be a server system, including physical servers that host multiple virtual machines.

In operation, the RX unit 103 receives video and/or audio output signals of the remote computer resource 106, from the TX unit 105, and provides the received signal(s) to the user station 101 for presentation to a user, through a video monitor at the user station in the case of a KVM system. The RX unit 103 also receives signals from the user station 101, including local mouse and/or keyboard data in the case of a KVM system, and sends these signals to the TX unit 105. At the computer resource side of the example system 100, the TX unit 105 obtains and sends video and/or audio output signals that are currently being output by the computer resource 106 to the RX unit 103, and also receives the user station signals, including mouse and/or keyboard data in an example above, from the RX unit and provides those signals to the computer resource to control the computer resource.

The RX and TX designations of the RX unit 103 and the TX unit 105 are in reference to transfer of video and/or audio signals between the user station 101 and the computer resource 106. These designations are not intended to indicate or imply that an RX unit is only able to receive or that a TX unit is only able to transmit, or even that video and/or audio signals may only flow in a direction from a TX unit to an RX unit. For example, some audio transfers can be conveyed in the opposite direction in some embodiments. Also, as discussed herein, the RX unit 103 may also transmit signals such as local mouse and/or keyboard data from the user station 101 to the computer resource 106, and the TX unit 105 may receive such signals from the RX unit.

Any of various approaches could be implemented to control signal transfer between the RX unit 103 and the TX unit 106. For example, the TX unit 106 may be configured to obtain and transmit output signals from the computer resource 106 responsive to a command or request from the RX unit 103. The RX unit 103 may be configured to send requests or commands for computer resource video and/or audio under control of the user station 101. A user could initiate a request or command to the RX unit 103 using an input device such as a keyboard or mouse, for example, or the user station 101 itself may automatically generate requests or commands or otherwise initiate video/audio signal transfer from the computer resource 106. In other embodiments, the TX unit 105 periodically obtains and transmits output signals from the computer resource 106 to the RX unit 103. The RX unit 103 may also or instead periodically and automatically generate and transmit requests or commands to the TX unit 105, and the TX unit then obtains and transmits output signals from the computer resource to the RX unit in response to those periodic requests or commands. Video and/or audio signal transfer may also or instead be initiated by the computer resource 106 itself. Embodiments that support both automatic and request-driven or command-driven computer resource video and/or audio transfer are also possible.

In some embodiments, a user or operator at the user station 101 selects the computer resource 106 for remote access. This is also referred to as attaching the user station 101 to the computer resource 106.

FIG. 2 is a block diagram of an example KVM matrix 200 to support simultaneous remote access to multiple computer resources by multiple user stations. In a sense, FIG. 2 can be considered as extrapolating the concept of the KVM extender shown in FIG. 1 to a matrix allowing the simultaneous multi-user access to multiple computer resources. In FIG. 2, a KVM manager 201 is coupled to a managed network switch 202 through a connection 210. The managed network switch 202 is coupled to a set 204 of user stations by a connection 212. The set 204 of user stations includes a number of receiver units 205a, 205b coupled to respective user stations 206a, 206b. Although two user stations 206a, 206b and two RX units 205a, 205b are shown, there may be more than two user stations and/or RX units in other embodiments. In addition, although a respective RX unit 205a, 205b is coupled to each user station 206a, 206b, in other embodiments a single RX unit may be coupled to and serve multiple user stations.

The managed network switch 202 is also coupled to a set 207 of computer resources through a connection 214. The set 207 of computer resources includes TX units 208a, 208b, 208c respectively coupled to computer resources 209a, 209b, 209c. Although three computer resources 209a, 209b, 209c and three TX units 208a, 208b, 208c are shown, there may be more or fewer than three computer resources and/or TX units in other embodiments. Also, a respective TX unit 208a, 208b, 208c is coupled to each computer resource 209a, 209b, 209c, in other embodiments a single TX unit may be coupled to and serve multiple computer resources.

In general, a KVM system may include more or fewer components than shown. For example, it is expected that most KVM installations will include more computer resources than user stations. A relatively small office installation may include ten to twenty computer resources and only five to ten user stations for example, whereas a video production control room might include one hundred to two hundred computer resources and twenty-five to fifty user stations.

The equipment and computing resources associated with a KVM system such as the KVM matrix 200 may be installed in a secure, environmentally controlled data center or equipment room, for example. Such equipment and computing resources may include at least the KVM manager 201 and the set 207 of computing resources in some embodiments. The user stations in the set 204 are at one or more remote locations, remote from at least the set 207 of computer resources. The managed network switch 202 may be co-located with the set 207 of computer resources and/or the KVM manager 201, or even be co-located with one or more of the user stations 206a-b. In other embodiments, the managed network switch 202 is remote from all of the other KVM matrix components.

Examples of user stations, RX units, TX units, and computer resources are provided elsewhere herein, at least above. At least the above examples relating to the connection 104 in FIG. 1 also apply to the connections 212, 214. These connections between the RX units 205a-b and the TX units 208a-c in FIG. 2 are switched connections in the example KVM matrix 200. Switched connections may also or instead be used in a KVM extender system such as the example system 100, but the RX unit—TX unit connections are shown differently in FIGS. 1 and 2 solely for illustrative purposes. Switched connections are not limited only to KVM matrix embodiments, at least to the extent that at least some form of switching may be performed in any network connection, for example.

Any of various types of managed network switches, examples of which are commercially available and known to those skilled in the art, may be implemented at 202. The present disclosure is not restricted to any particular type of network switch.

The connection 210 between the KVM manager 201 and the managed network switch 202 provides a link to receive data from and/or to transmit data to the RX units 205a-b and/or the TX units 208a-c. Data flowing across the connection 210 may include, for example, requests and/or status information from RX units 205a-b and/or TX units 208a-c to the KVM manager 201; commands and/or status information from the KVM manager 201 to the RX units 205a-b and/or the TX units 208a-c; configuration and/or upgrade commands for the RX units 205a-b and/or the TX units 208a-c, issued by Information Technology (IT) personnel connected through a Graphical User Interface (GUI) implemented on the KVM manager 201 for example. These examples of data that may be transferred across the connection 210 are not exhaustive. In some embodiments, connection 210 may be implemented as a copper network cable; in other embodiments, connection 210 may be implemented as a fiber-optic cable; and still other embodiments combine the managed network switch 202 and the KVM manager 201 into a single system, and connection 210 would be made internally within the combined system.

The KVM manager 201 includes at least a controller and a communications interface to support communications with the managed network switch 202. At least the controller may be implemented using hardware, firmware, components that execute software, or some combination thereof. Examples of electronic devices that might be suitable for this purpose are provided elsewhere herein, at least above. A more detailed example of a KVM manager is also disclosed elsewhere herein.

The KVM manager 201 provides control over other components within the KVM matrix 200. For example, the KVM manager 201, or more specifically the controller therein, may route and/or otherwise process all requests issued by any of the RX units 205a-b to connect to any of the TX units 208a-c. In some embodiments, an operator at a user station 206a-b may select any of the remote computer resources 209a-c, which is then “attached” to that user station to give the user full and exclusive control of the selected computer resource. Other operators at other user stations 206a-b can similarly select and attach to any of the available computer resources 209a-c. Such computer resource selection generates requests that are routed to the KVM manager 201 by the RX units 205a-b, and attachment of computer resources 209a-c to user stations 206a-b is managed by the KVM manager 201 based on the requests.

It should be noted that multi-user access to computer resources is not necessarily exclusive. For example, in some embodiments a single computer resource may be simultaneously accessed by multiple users through multiple user stations. Even with shared access, some aspects of access may be exclusive. One user station may have exclusive control of a computer resource that is being accessed by multiple user stations, for example.

The KVM manager 201 may also or instead implement other features such as adding user stations and/or computer resources to the KVM matrix or removing user stations and/or computer resources from the KVM matrix. The KVM manager 201 may also or instead be configured to manage user accounts across the matrix 200 and enforce particular user-based access rights to any of the computer resources 209a-c from any of the user stations 206a-b. In some embodiments, the KVM manager 201 provides named system access, illustratively through the use of menus of any of the RX units 205a-b. Regarding named system access, rather than address systems by a number or address such as “192.168.3.54”, in some embodiments components such as TX units and/or RX units can also or instead be assigned textual or otherwise more user-friendly names such as “Reactor Cooling Control” or “News Server 3”. Software upgrades may also be made across the system through the KVM manager 201. Other features may also or instead be provided in other embodiments.

Monitoring and control of computer systems such as the computer resources 209a-c can become quite a complex and daunting task, especially with an increasing number of resources. Consider an example of two hundred computer resources 209a-c and fifty user stations 206a-b. Even with fifty operators, each continuously monitoring four of the computer resources, the chance of a significant error or operational issue being missed can be quite high. Operators may be distracted, or at the very least a multi-window display screen of the type that is common in KVM systems may lose an operator's full attention, at least at times. Also contributing to potential monitoring and control issues is the fact that at least certain types of errors and/or other conditions might not necessarily result in a significant change in an operator's screen. In the above example of an operator monitoring four computer resources, any change in a computer resource display such as the appearance of a popup window would translate into a change in just one of four display signals being monitored by an operator, all of which may be changing at the same time, and in a window that is likely smaller than the display screen at the computer resource. By the time an issue is recognized by an operator, it may already be too late to take action in time to avoid or alleviate related issues or impact.

In this context, AI may be an attractive candidate to provide improved monitoring and control. Implementation of an AI solution across even an existing computer system may add increased functionality for both end users and an organization itself. However, AI implementation involves factors of additional financial cost, additional computational cost, and significant additional space and power. As a result, AI implementations are often overlooked or not considered viable, especially in installations with a large number of computer systems, which is actually where AI might be the most useful and valuable.

Therefore, even though AI could potentially drive a fundamental shift in how people interact with computers, including the ability to recognize and analyze digital video and audio for example, such factors as those noted above have largely constrained the growth and implementations of AI to applications that can be hosted in the cloud, where the majority of AI hardware can potentially be localized into large data centers. Because of this, many computer systems such as desktop and laptop computers, industrial computers, single-board computers, etc., will likely be passed over by the AI revolution.

A tensor core, also often referred to as a tensor, is a basic building block of modern machine learning and AI. It is in effect a data container that may include numbers and strings, and may be multi-dimensional, ranging from 1 to 5 dimensions for example. Tensor acceleration cards may be inserted into desktop computers or other computer systems to add AI capabilities. However, computer system architecture might not allow a tensor accelerator to access key data, such as audio and video information, or to access or provide key functionality such as control of the computer. Bypassing such architecture may be possible through augmentation of a tensor accelerator card with additional technologies, such as video framebuffers, audio interfaces, and mouse and keyboard emulators, but this further increases cost, complexity, and power consumption.

The cost associated with per-computer system AI implementation can easily surpass multiple times the cost of a computer system itself, and this already high cost would be incurred for each of an organization's computer systems.

For at least these reasons, AI solutions have not been widely adopted for monitoring and control of computer resources. Embodiments of the present disclosure provide unique and novel techniques to extend AI to desktop, laptop, and/or other computer resources, without requiring per-system AI implementation. In some embodiments, an AI system is effectively shared among multiple computer systems using KVM-type technology, in which the AI system does not interact with computer systems over a traditional computer network, but instead “sees” and “hears” each of the computer systems through analysis of real-time video and audio data that is already flowing through the KVM system. This may support an ability of an AI-RCS to monitor and analyze any computer systems connected to a KVM system using the KVM system native audio and video data. An AI-RCS may also or instead control any of the computer systems connected to a KVM system using the KVM system's native control data.

The present inventors have discovered that coupling and integration between an AI system and a KVM system may bring new capabilities and benefits to computer systems that are connected in a KVM system, and such capabilities and benefits may also extend to other types of system as well, beyond systems that may traditionally be considered KVM systems.

KVM matrices such as the KVM matrix 200 shown in FIG. 2 may be augmented with AI capabilities through the use of an AI-RCS as disclosed herein. In an embodiment, the resulting system enables the AI-RCS to analyze real-time audio and video data flowing between computer systems within a KVM network.

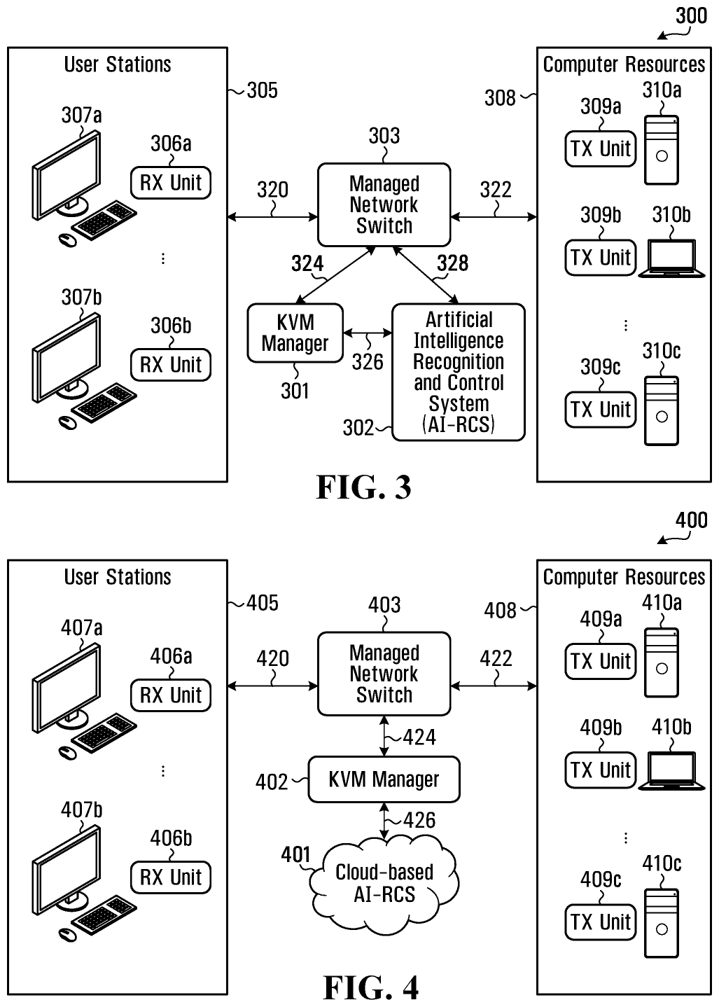

FIG. 3 is a block diagram of another example KVM matrix, with the addition of an AI-RCS to provide an AI-RCS enabled KVM system 300. A KVM manager 301 is coupled to an AI-RCS 302 through a connection 326, and both the KVM manager and the AI-RCS are further coupled to a managed network switch 303 through respective connections 324, 328 in the example shown. The managed network switch 303 is coupled to a set 305 of user stations 307a-b with RX units 306a-b through a connection 320. The managed network switch 303 is also coupled to a set 308 of computer resources 310a, 310b, 310c with TX units 309a, 309b, 309c through a connection 322. Although only one connection 320 and one connection 322 are illustrated in FIG. 3 to avoid congestion in the drawing, there may be multiple connections between the managed network switch 303 and the RX units 306a-b, such as one connection per RX unit, and/or multiple connections between the managed network switch 303 and the TX units 309a-c, such as one connection per TX unit.

Examples and implementation options for most of the components of FIG. 3 are provided at least above, with reference to similarly-labeled components in FIG. 2. In an embodiment, the AI-RCS 302 is a hardware system, and may be local to the KVM manager 301 and managed by local operators using one or more management terminals or systems (not shown) through which the KVM manager is also configured and/or controlled. The AI-RCS 302 may be implemented in a set of one or more Very Large Scale Integration (VLSI) integrated circuits that can fit onto a single printed circuit board or may be reduced to a single FGPA device, for example. AI accelerator hardware such as a tensor Graphics Processing Unit (GPU) is another implementation option for the AI-RCS 302. Although shown as a separate component in FIG. 3, the AI-RCS 302 may be embedded within or otherwise incorporated into other components, including not only the KVM manager 301, but potentially one or more of the computer resources 310a-c, the TX units 309a-c, the RX units 306a-b, and/or the user stations 307a-b.

The connection 326 is used by the KVM manager 301 to issue commands to the AI-RCS 302, to begin a recognition and control process as disclosed herein for example, and to receive the subsequent results back from the AI-RCS. The connection 328 is used to deliver video, audio, and/or other data to the AI-RCS 302 for analysis. The routing of this data across connection 328 from one of the TX units 309a-c is established by the KVM manager 301 prior to sending commands to the AI-RCS 302 in some embodiments. In another embodiment, the AI-RCS 302 can send its own data routing commands across connection 328 to the managed network switch 303, and then receive routed data from one of the TX units 309a-c across the same connection 328. In some embodiments, connections 324, 326, and 328 may be implemented as copper network cables; in other embodiments, connections 324, 326 and 328 may be implemented as fiber-optic cables; in some other embodiments connections 324, 326 and 328 may be a mixture of copper and fiber-optic cables; and in still other embodiments the managed network switch 303 and/or KVM manager 301 and/or the AI-RCS 302 may be combined into a single system, and connections 324, 326 and/or 328 would be made internally within the combined system.

A cloud-based AI-RCS is also possible. FIG. 4 is a block diagram of a further example KVM matrix, with the addition of a cloud-based AI-RCS, illustrating another embodiment of an AI augmented KVM matrix 400. In comparison with FIG. 3, the AI-RCS 302 in FIG. 3 is replaced by a cloud-based AI-RCS 401. The cloud-based AI-RCS 401 is coupled to and communicates with a KVM Manager 402 through a connection 426, and the KVM manager is also coupled to and communicates with a managed network switch 403 through a connection 424. The managed network switch 403 is coupled to a set 405 of user stations 407a-407b through RX units 406a-406b and a connection 420. The managed network switch 403 is also coupled to a set 408 of computer resources 410a, 410b, 410c through TX units 409a, 409b, 409c and a connection 422.

The embodiment in FIG. 4 is substantially the same as the embodiment in FIG. 3, with the exception that the AI-RCS 401 is cloud-based. The connection 426 in this embodiment may be a network connection that supports high-bandwidth data communications across the Internet between the KVM manager 402 and the cloud-based AI-RCS 401. In another embodiment, the connection 426 may be a dedicated point-to-point connection to the cloud-based AI-RCS 401 utilizing technologies such as fiber trunk, microwave or satellite communications. This list is not exhaustive, and other types of connection are possible.

The cloud-based AI-RCS 401 is, in some embodiments, hosted within a cloud by an external organization that may, or perhaps more likely does not, have an affiliation or association with an owner of the remainder of the system 400. In one common topology and business model, the external organization charges a monthly subscription fee for use of the cloud and employs its own operators to manage the cloud-based AI-RCS 401.

Turning now to operation of an AI-enabled KVM matrix, of which FIG. 3 and FIG. 4 are illustrative examples, there are several possible embodiments of either a physically present AI-RCS 302 or a cloud-based AI-RCS 401. In one embodiment, an AI-RCS is capable of performing several recognition and control tasks; alternatively, an AI-RCS may be designed to perform a single task and thus may be reduced to a minimal set of components.

Recognition and control datasets for use by an AI-RCS may be developed through training the AI-RCS with simple imagery in embodiments in which recognition and/or control features are to be applied to images or video. In other embodiments, recognition and control datasets may be trained using specific attributes. An attribute may be language, and may encompass any of various languages, such as English, French, and German for example. One or more attributes may be manufacturer-specific and dependent upon such factors as GUI style and data protocol(s) used to control equipment.

In an embodiment, an AI-RCS and its components, such as datasets, may be purchased or licensed by an organization without a time limit; alternatively, some AI-RCS components may be licensed for a fixed period of time or be provided as part of a subscription. Therefore, an entity that implements an AI-RCS need not necessarily also perform training or develop datasets for operation.

An AI augmented KVM matrix with the inclusion of an AI-RCS, as seen in FIG. 3 and FIG. 4, supports the ability to scan each computer system, including computer resources and/or user stations, connected to a KVM system. The number of monitored computer systems may range from just a few to several thousand or more.

Scanning speeds of a KVM system may vary according to such factors as the number of computer systems to be scanned, properties of an AI-RCS such as the number of AI engines in an AI-RCS resource pool, and/or the complexity of recognition datasets, for example. With the time required to analyze KVM and digital data from a computer system ranging from tenths of a second to several seconds in some embodiments, a large network may require several minutes to scan in its entirety.

One approach to potentially increasing scanning speed is implementing multiple or additional AI engines within an AI-RCS resource pool. This approach provides additional capacity for simultaneous scanning and may reduce scanning time for a complete scan. Another approach that may also or instead be applied involves organization of computer systems that are to be scanned into groups, based on priority level and/or desired scanning frequency for example. A grouping approach concentrates scanning capacity on higher priority computer systems or computer systems that are to be scanned more often than others.

In an embodiment, the following sequence is used to scan and analyze every computer within a KVM system 300, 400. The KVM manager 301, 402 routes video and audio data from a selected computer system that is to be scanned to the AI-RCS 302, 401 through the connection 326, 426, which may actually be a connection through the managed network switch 303, 403 in some embodiments. It is important to note that the KVM manager 301, 402 manages all access to computer resources and routing of video/audio data between computer resources and user stations in some embodiments, and therefore this routing may involve intercepting or otherwise obtaining video and audio data that is already flowing through the managed network switch 303, 403, and routing that data not only to an intended RX unit 306a-b, 406a-b, but also to the AI-RCS 302, 401.

The KVM manager 301, 402 may then issue a request or command to the AI-RCS 302, 401, indicating that the video and audio data from the selected computer system is being transmitted and that the data is ready for analysis. Data routing and analysis may be initiated and/or driven by the AI-RCS 302, 401 in other embodiments. The AI-RCS 302, 401 may request and obtain data from the KVM manager, or even from computer systems directly in some embodiments, and proceed with analysis of data as it is received.

Video and audio data are analyzed by the AI-RCS 302, 401, responsive to a request or command from the KVM manager 301, 402 in some embodiments, and zero-to-many events are generated based on the data and event rules. Received data might not satisfy a condition for taking action for example, in which case the AI-RCS 302, 401 need not generate and event. In the case of one or more action or event conditions being satisfied or detected, the AI-RCS 302, 401 generates one or more events, examples of which are provided elsewhere herein.

A scanning sequence such as the sequence outlined above may repeat, with the KVM manager 301, 402 selecting a next computer system for scanning and analysis.

In another embodiment, the AI-RCS 302, 401 in effect acts as the KVM manager 301, 402 in respect of scanning functions, and controls the KVM system 300, 400 to collect scanning data. To do so, in an embodiment the AI-RCS 302, 401 first issues requests or commands to the managed network switch 303, 403 to route to the AI-RCS any or all video/audio data that is flowing through the switch or video/audio data from one or more specific computer resources. The AI-RCS 302, 401 then automatically starts analysis and generates zero-to-many events based on the analysis. In a sequential processing approach, the AI-RCS 302, 401 then steps to the next computer system that is to be scanned.

It should be noted that video/audio data represents just one example of scanning data. One or more images that are being output at a computer system, for example, may also or instead be routed to an AI-RCS 302, 401 for analysis. Video is a series of images, and accordingly image scanning and analysis is a logical extension of the teachings herein. Control data in a KVM system could also or instead be routed to an AI-RCS 302, 401 for analysis.

Although the examples above refer to images, video, and audio or data from computer resources or computer systems, embodiments are not in any way restricted to scanning and analysis related to computer resources 310a-c, 410a-c. User stations 307a-b, 407a-b may also or instead be subject to scanning and analysis. In the context of user stations 307a-b, 407a-b, control data monitoring and analysis could be especially desirable. One or more control streams associated with one or more user input devices, such as a keyboard, mouse, touchscreen, and/or any other human interface device for example, may be monitored.

Consider a computer resource A in a controlled area being operated by a user station B, also in a controlled area, with A and B attached through a KVM network in which an AI-RCS is also deployed. In some embodiments, a KVM Manager in the KVM network and/or the AI-RCS are authorized and configured to contribute or supplement control of computer resource A. Embodiments in which the AI-RCS also or instead monitors the user station B and/or other user stations for “rogue” or unauthorized control traffic and blocks, otherwise circumvents, and/or reports such control traffic are also contemplated. For example, an AI-RCS interface as described at least below may enable an AI-RCS to monitor user input devices at a user station even in non-KVM embodiments.

An AI-RCS may automatically scan the entire set of computer systems, including user stations and/or computer resources, attached to a KVM system. Such scanning may be performed in the background, and with no active user control. Scanning may also be performed while users are operating user stations and/or monitoring/controlling computer resources, to provide background and transparent automated and AI-augmented monitoring and control capabilities.

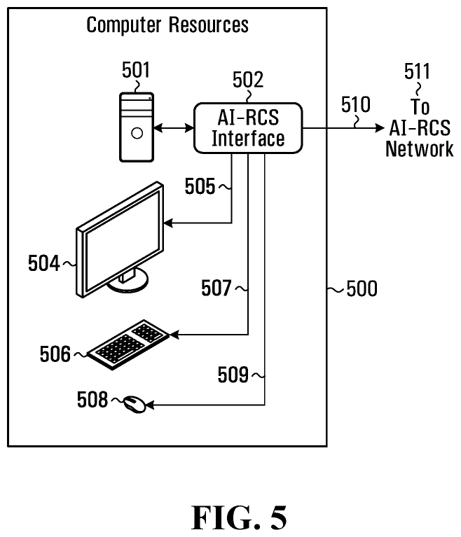

AI augmentation or integration is not limited only to KVM applications. FIG. 5, for example, is a block diagram of an embodiment of an AI-RCS interface shared among several user stations, wherein a full KVM system has not been implemented. Within a computer station 500, a legacy computer 501 is coupled to an AI-RCS interface 502. Legacy computers may include, but are not limited to: legacy desktop computers, laptops, industrial computers, single-board computers, and data tablets. The AI-RCS 502 interface may also be coupled to other computer station components, such as: a display 504 through a connection 505, illustratively a video cable; an I/O or control peripheral 506 such as a keyboard as shown, through a connection 507; and a second I/O peripheral 508 such as a mouse as shown, through a connection 509. The AI-RCS interface 502 communicates with an AI-RCS, shown in FIG. 5 as an AI-RCS network 511 to illustrate that the example shown may be part of an AI-RCS network in which an AI-RCS is shared by multiple computer stations, through a connection 510.

In an embodiment, the AI-RCS interface 502 is integrated into the legacy computer 501, and the connection between the legacy computer and the AI-RCS interface is an internal connection, through a card slot for example. Other examples of the connection between the legacy computer 501 and an AI-RCS interface 502 include those provided elsewhere herein in respect of connections between RX units and user stations. A video cable and a display cable are example implementations of the connection 505. In an embodiment, the connection 507 is a keyboard cable and the connection 509 is a mouse cable. USB connections and wireless connections are also common for a keyboard such as 506 and a mouse such as 508.

The I/O devices 504, 506, 508 are shown by way of example in FIG. 5, but embodiments are not limited to these I/O device or peripheral device types. For example, audio peripherals and audio cables may also or instead be included in some embodiments, wherein an audio peripheral may be a speaker and an audio cable may be a speaker cable. In other embodiments, any or all peripheral devices may use various wireless technologies for connectivity.

The AI-RCS interface 502 may be implemented in much the same way as an RX unit, with at least a signal handler and one or more interfaces to computer station components and the AI-RCS connection 510. In the case of an AI-RCS interface 502, however, signal transfer supported by a signal transfer is to and potentially from an AI-RCS, as well as between the legacy computer 501 and the I/O devices 504, 506, 508 in an AI-RCS interface embodiment as shown in FIG. 5, with the I/O devices coupled to the legacy computer 501 through the AI-RCS interface 502. Example implementations of a signal handler and interfaces are provided elsewhere herein.

Through the connection of the AI-RCS interface 502 to both the legacy computer 501 and the I/O devices 504, 506, and 508, the legacy computer 501 may be controlled by a user of the I/O devices and also have its activity monitored or accessed by a remote AI-RCS in the AI-RCS network 511. In another embodiment, the connections 505, 507, 509 are connections to the legacy computer 501 and the AI-RCS interface 502 connects to the I/O devices 504, 506, 508 indirectly, through the legacy computer 501, while still enabling computer station user control and monitoring by an AI-RCS in the AI-RCS network 511.

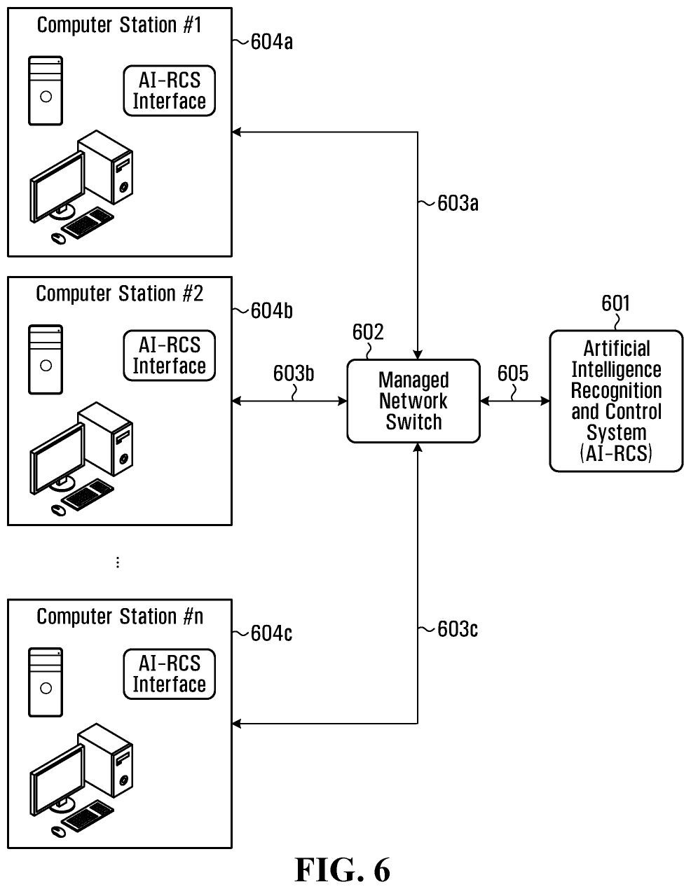

FIG. 6 is a block diagram illustrating a system in which an AI-RCS 601 is implemented in conjunction with and coupled to several user stations 604a, 604b, 604c through a managed network switch 602 and connections 603a, 603b, 603c, 605. FIG. 6 illustrates an extension of an AI-RCS interface introduced in FIG. 5 across several computer stations through the managed network switch 602. The AI-RCS 601 is coupled to the managed network switch 602 through the connection 605, and the managed network switch 602 is coupled to the computer stations 604a-c through the connections 603a-c.

The computer stations 604a-c include the same components as the computer station 500 in FIG. 5. Internal connections within each computer station 604a-c are not shown in FIG. 6 to avoid congestion in the drawing. Example implementations of the AI-RCS 601, the managed network switch 602, and the connections 603a-c, 605 are provided elsewhere herein.

The AI-RCS 601 may scan the entire set of computer stations 604a-c, analyzing one or more of the computer stations 604a-c at a time, generating zero or more events as appropriate based on the analysis, and proceeding to one or more other computer stations until all computer stations that are to be scanned have been scanned. The scanning process may be repeated continuously, periodically, according to a schedule, and/or as requested or initiated at one or more of the computer stations 604a-c, the AI-RCS 601, or elsewhere in a system, for example. The presence of the AI-RCS interfaces at the computer stations 604a-c in this embodiment may reduce costs associated with AI augmentation relative to augmenting each computer station with AI and/or implementing the computer stations in a KVM system.

In some embodiments, one or more rule sets are applied by an AI-RCS to determine a disposition of incoming data and any events to be triggered based on that incoming data. There are several possible embodiments of rule set applications within the AI-RCS. In one embodiment, a rule set relates to a default recognition operation to a computer system that does not have an assigned grouping within a network or KVM system. The default recognition operation may search for critical warnings or error indications at a computer system while disregarding additional information, for example. A warning or error message may trigger one or more particular AI-RCS events, such as any one or more of: notifying IT staff and/or other staff, logging an entry, and/or sending a communication such as a text message or an email to an operator of the computer system.

Another embodiment involves the use of a rule set for a grouping of computer systems, such as those that a user wishes to designate certain computers on a KVM system as being critical. Recognition operations may be applied to such a grouping, instead of or in addition to other recognition operations that apply to specific computer systems and/or are generic to all computer systems. For example, computer systems within an organization's accounting department may have additional recognition operations related to financial activities applied to them. Embodiments of rule sets that are applied within AI-RCS analysis or processing include but are not limited to these embodiments. Other embodiments are also possible.

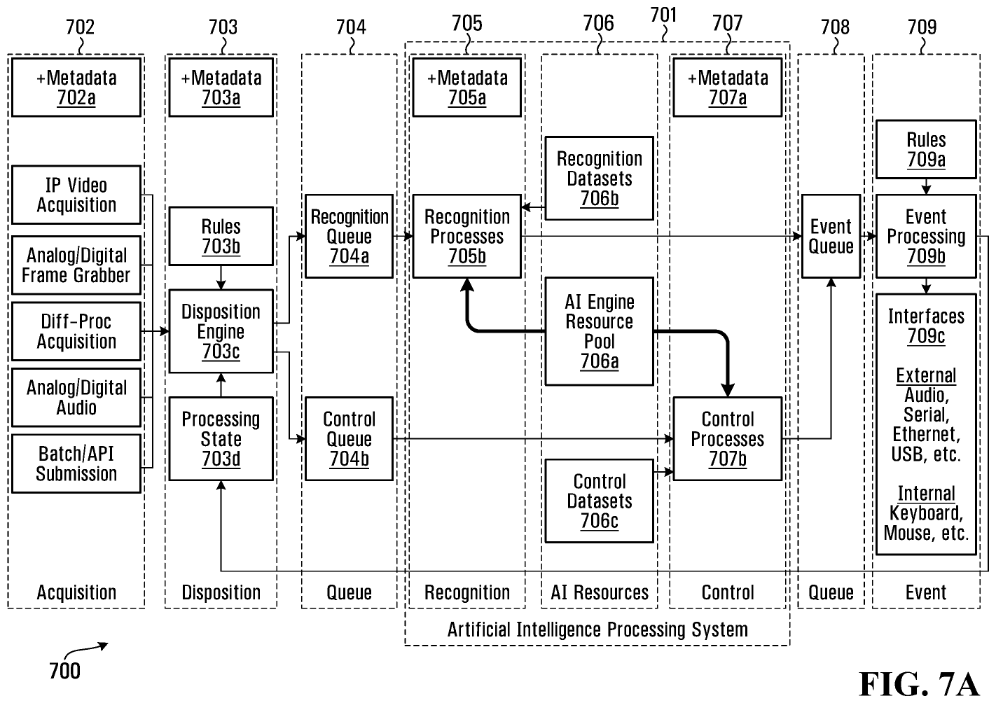

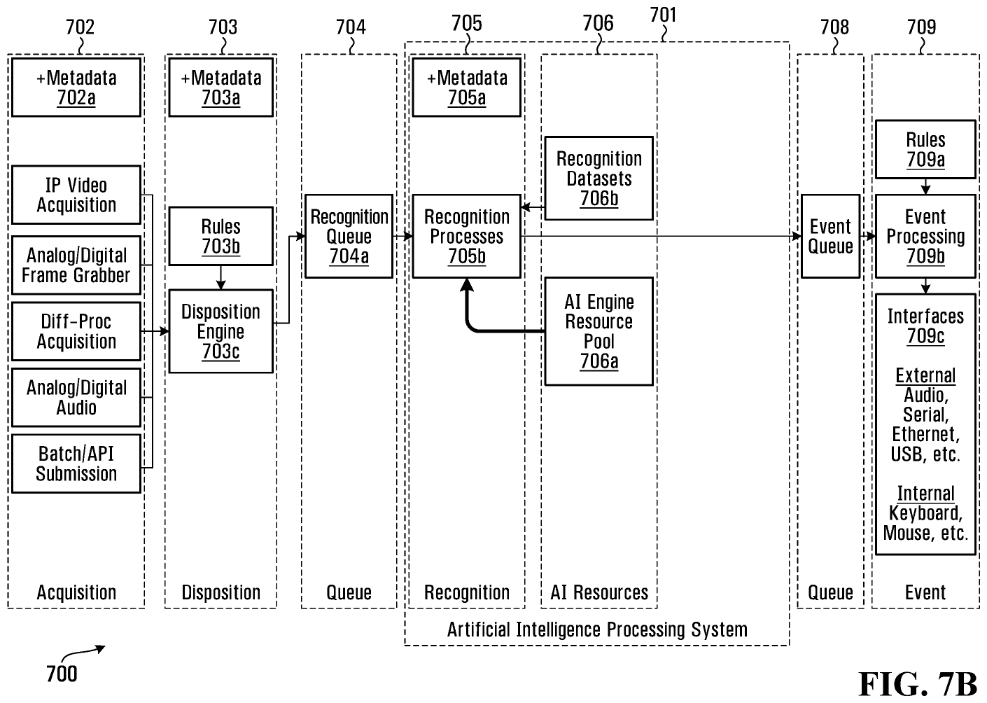

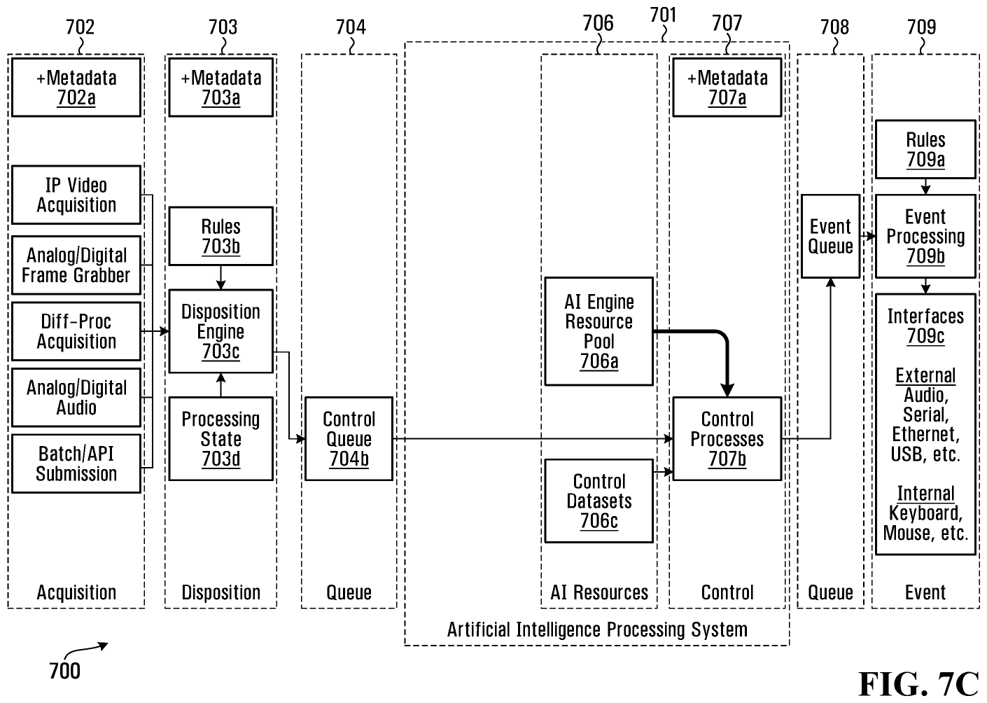

FIG. 7A is a diagram illustrating data flows within an example AI-RCS pipeline. The example 700 begins with an acquisition phase 702. Acquired data enters into and moves along the pipeline to a disposition phase 703. Data output from the disposition phase 703 enters into a queue phase 704 before entering into subsequent phases associated with an artificial intelligence processing system 701. The artificial intelligence processing system phases include a recognition phase 705, AI resources 706, and a control phase 707. Following the completion of AI processing, AI-processed data is returned to a further queue phase 708 before the data enters an event phase 709. Other embodiments may include additional, different, and/or fewer phases than shown.

In the acquisition phase 702, data such as image data, video data, and/or audio data associated with one or more computer systems is received by an AI-RCS through any one of several interfaces, illustrative and non-limiting examples of which are shown. The examples include an IP video acquisition interface, an analog/digital frame grabber interface, a diff-proc acquisition interface, an analog/digital audio interface, and a batch/Application Programming Interface (API) submission interface.

The IP video acquisition interface may be used, for example, when video and audio data are formatted for transmission across a computer network. An example of such a video format is SMPTE ST 2110 (Professional Media Over Managed IP Networks). In other embodiments, a proprietary IP video format is used in a KVM system, for example, and a compatible interface is provided for data acquisition.

Embodiments may also or instead provide an analog/digital frame grabber interface, when video is supplied by a traditional video source for example, such as a graphics card. Examples of this video type include but are not limited to High Definition Serial Data Interface (HD-SDI) according to SMPTE 292M/372M, High Definition Multimedia Interface (HDMI), single-link and dual-link Digital Visual Interface (DVI), DisplayPort™, and Video Graphics Array (VGA).

A batch/API submission interface is also shown as an example in FIG. 7A. Such an interface is used in some embodiments to support submission of a single frame of video, a video file, or an audio file for analysis. Submission may occur through the use of a software API across a computer network or via an external memory drive containing the file or files to be analyzed, for example. An external memory may be or include USB drive, although other types of external memory may also or instead be used.

An analog/digital audio interface is provided in some embodiments to support acquisition of audio data. Audio signals, especially embedded digital audio data, add some extra complexity for acquisition. For example, a single frame of video occupies a single still picture of a continuously moving stream, and when audio is embedded with the video a very small sub-sample of the audio is included. At 30 frames-per-second, for example, an audio segment lasts only 33.3 milliseconds, which is not likely enough time for the segment to be intelligible. Even single words can be spread across multiple video frames.

Whether audio is embedded with video as part of a digital stream or is a separate analog or digital input, during the acquisition phase 702, a window of audio large enough that intelligible sound can be extracted may be created. As an example, an AI-RCS could be configured to maintain the last 7 seconds of audio, and as each video frame arrives, its short audio segment is appended to the current window to keep the audio file current.

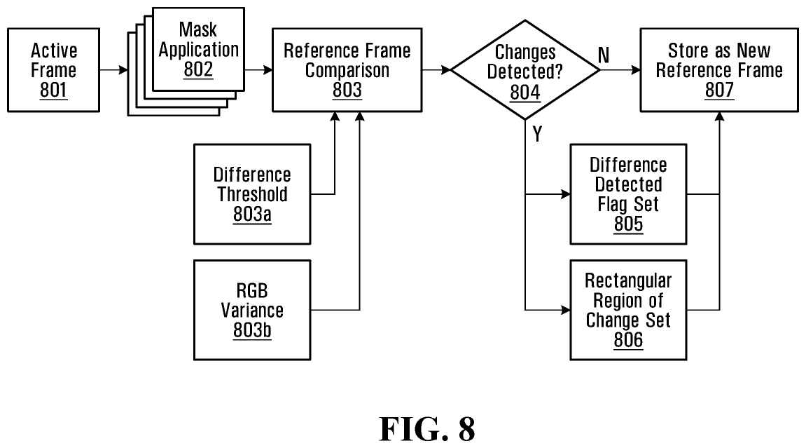

The diff-proc interface relates to difference processing. FIG. 8 is a flow diagram illustrating operation of a diff-proc interface according to an embodiment. The illustrated operations may be implemented, for example, using hardware, firmware, components that execute software, or a combination thereof.

In FIG. 8, an active frame 801 is initially selected, and a mask is applied to the active frame at 802, to mask out areas of a frame that are not of interest for detection of changes. Then, a reference frame comparison 803 is performed. This may be through the application of a difference threshold 803a and/or observation of Red-Green-Blue (RGB) variance 803b, for example. In some embodiments, the difference threshold 803a specifies a number of pixels that must change in order for a change to be detected, and the RGB variance 803b specifies a degree of pixel color change for a change to be detected.

It is then determined at 804 whether changes in the active frame 801 relative to the reference frame are detected. If so, then a difference detected flag is set at 805 and a rectangular region of change is set at 806. A flag and rectangular area 805, 806 are just illustrative and non-limiting examples of how a detected change is indicated in some embodiments. The active frame 801 may be stored as a new reference frame at 807, for use in detecting subsequent changes in an area of interest. If no changes are detected in the current active frame 801 relative to the current reference frame, then the current active frame is still stored as a new reference frame at 807 in the example shown. In other embodiments, storage of a new reference frame is responsive to detecting a change. If no change is detected, then there may be no need to store a new reference frame. This latter option may be more suited to detection of less prominent changes that occur over time, between multiple frames, rather than just changes that exceed a threshold between one frame and the next frame.

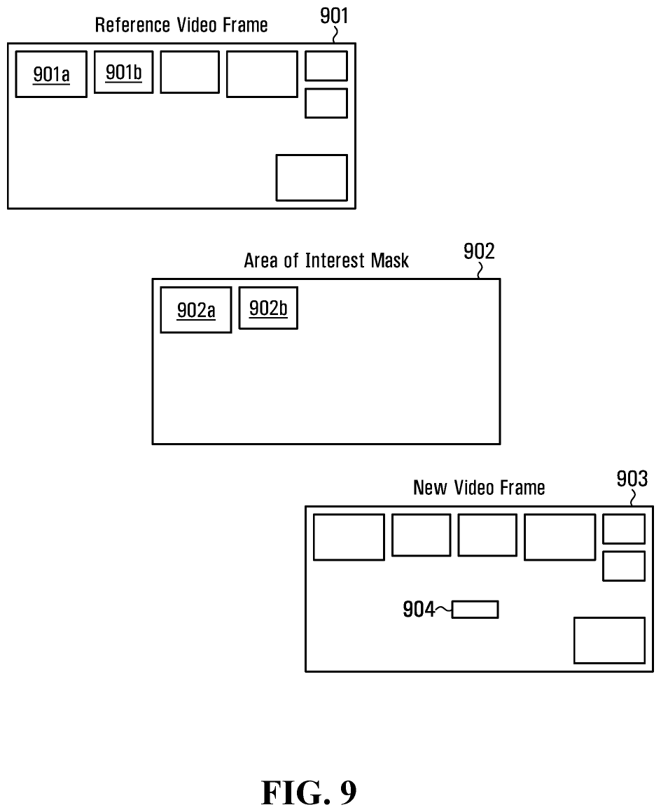

FIG. 9 is a block diagram illustrating an example of comparison of video frames according to an embodiment of difference processing. The reference video frame 901 includes several video components within the frame. The video components are shown as blank blocks in FIG. 9 so that the drawing will be clear, but in practice each block includes an image. The reference frame 901 may be a frame capture from a multiviewer screen, for example, in which multiple video signals from multiple computer systems in a KVM system are presented to a user, for example.

The video frame components 901a, 901b are labeled in FIG. 9 to illustrate components that are disregarded for the purpose of change detection by applying the area of interest mask 902. In the example shown, the video components 901a, 901b are masked out of an area of interest by video mask components 902a, 902b, respectively. In general, a mask identifies an area of interest for change detection. A mask component may exclude one or more components or areas of a video frame from change detection. A mask may also or instead include one or more mask components that are applied to select or include one or more components or areas of a video frame for change detection. In other words, one or more components of a video frame may be masked out of or masked into change detection.

Through comparison of the reference video frame 901 with a new video frame 903, and also taking the mask into account, differences such as a new pop-up 904 are identified.

Difference processing, such as shown by way of illustrative example in FIG. 8 and FIG. 9, enables changes to be detected between video frames 901, 903 in a real-time video stream. Once this detection occurs, boundaries of a change can be identified, extracted, and processed by an AI-RCS, in the same manner as for data acquired through one or more other interfaces in FIG. 7A, such as the batch/API submission interface. The diff-proc interface, however, limits an area of analysis, thereby potentially allowing at least the recognition phase to run more quickly. With difference processing, a frame or image to be analyzed is constrained to only an area that has changed, and therefore may be much smaller than a full frame or image. With a smaller frame or image of only an area that has changed, recognition speeds could approach several orders of magnitude faster than recognition based on an entire video frame or image.

Embodiments are not in any way restricted only to difference processing as described above. Techniques as disclosed in U.S. Pat. No. 7,779,361, for example, may also or instead be implemented in some embodiments.

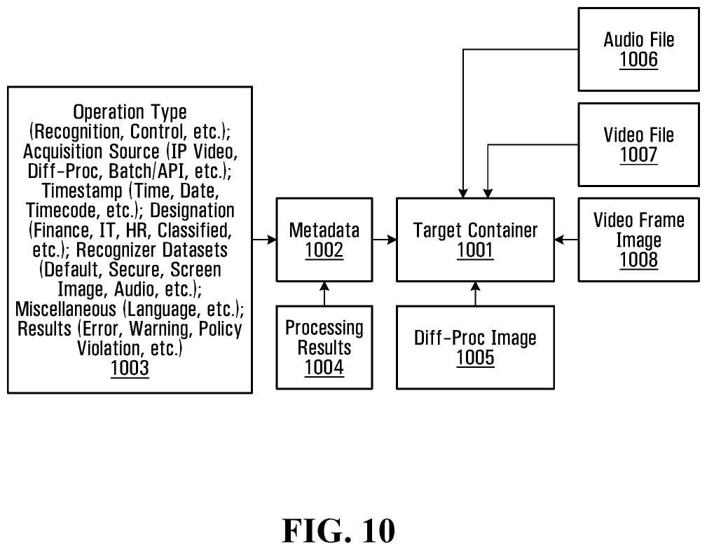

A target container is referenced above in the context of the acquisition phase 702 in FIG. 7A. FIG. 10 is a block diagram illustrating an example of a target container and its contents according to an embodiment. The example target container 1001 is a data construct that stores a collection of files, and includes metadata 1002, an audio file 1006, and a video file 1007. The example target container 1001 also includes a video frame image 1008, and in some embodiments, a diff-proc image 1005 is also or instead included in a target container.

The metadata 1002 includes data 1003 that is relevant to AI processing, as well as processing results 1004. At the acquisition phase, a target container does not include, for example, at least processing results because AI processing has not yet been completed. The metadata 1002 may be supplemented as processing of a target container proceeds, and therefore it should be appreciated that some of the metadata 1002 shown in FIG. 10 is additional information that is generated or otherwise gathered during AI-RCS operations, to assist in subsequent processing for example. The metadata 1002 in a target container may include, but is not limited to, any one or more of the examples shown at 1003, 1004: operation type such as recognition or control; data source, such as one or more of the interfaces shown in FIG. 7A; a timestamp, including the time, date, and/or timecode; data designation(s) within an organization, such as Finance, IT, Human Resources (HR) and/or classified; recognition or recognizer dataset(s), such as default, secure, screen image, and/or audio; miscellaneous information such as language; and results data, such as errors, warnings, and/or policy violations. Other examples include: data type, for example video or audio; and classification type, such as an office computer system or a computer system in a secure lab. Any of various other types of metadata may be collected and stored, in addition to or instead of any of these examples

Other contents of the example target container 1001 are also shown to provide a more complete example but need not necessarily be present in every target container. For example, a target container might include one audio or video component 1005-1008 and metadata 1002 with the original source and other acquisition information, with disposition information and results from the AI processing 1004 being added during processing.

The contents of the example target container 1001 remain associated with each other or “bundled” together in the target container during processing, as the target container passes through the processing pipeline in FIG. 7A for example. Throughout phases of a processing pipeline, including the acquisition, disposition, recognition, and control phases 702, 703, 705, 707 in FIG. 7A, additional metadata, and potentially other information, may be added to the target container 1001, as shown at 702a, 703a, 705a, 707a.

Returning now to the example AI-RCS pipeline 700 in FIG. 7A, data acquired during the acquisition phase 702 through any of the acquisition interfaces shown or possibly otherwise, is provided in one or more target containers for further processing in the disposition phase 703.

During the disposition phase 703, a determination is made by a disposition engine 703c in the example shown, to either queue the target container for processing by the AI system or to reject and delete the target container. If a determination is made to further process the target container, then additions and/or other modifications may be made to the existing metadata as illustrated at 703a to alter subsequent AI-RCS processes.

A set of one or more rules is illustrated at 703b and is provided for use by the disposition engine 703c to make the determination as to whether to process the target container, to process the target container with modifications, or to reject the data within the target container. Some examples as to how the rules may be provided include text configuration files, a graphical user interface, and system registries. Possible methods of providing rule sets for the disposition phase 703 are not limited to these examples.

Any of several types of rules may be applied by an AI-RCS, such as any one or more of: physical location rules, for instance, requiring computer systems located in high security areas to include metadata instructing additional recognition processes related to classified data; user profile rules, for example, including metadata instructing additional recognition processes relating to financial activities for individuals in finance or accounting departments; dataset rules, such as updating metadata for video received via diff-proc acquisition methods to improve subsequent processes by tuning a recognition dataset; and data source rules, which may include updating metadata for video received from a broadcast network's Quality Assurance (QA) department to add a recognition dataset to identify potential copyright or other legal issues.

In addition to or instead of operator-provided rules, current processing state 703d may be used to determine whether a target container will be further processed. In an embodiment, there are two critical states, including an “ignore” state and a “control” state, although other states may also be applied.

The “ignore” state is applied to a new target container if a target container from a previous recognition event causes an event that has not yet been handled. For example, it may be useful to suspend further processing related to scanning of a particular computer system for which an error dialog has appeared, until that error dialog has been cleared. Once the “ignore” state has been applied, the disposition engine 703c deletes the new target container and exits the pipeline 700, preventing further processing and associated consumption of system resource. Following the completion of the previous recognition event, the “ignore” state is removed and subsequent data for the affected computer system may be further processed by the AI-RCS.

The second state in this example, the “control” state, is applied to a target container when a target container from a previous recognition phase causes an event that is configured to be handled via control of the computer system. Application of the “control” state routes subsequent target containers associated with the affected computer through control processes as opposed to recognition processes. The AI-RCS transmits keyboard and mouse commands to the affected computer system to cause operations to handle the previous event to be performed by the affected computer system. The “control” state is removed after the AI-RCS executes the appropriate control functions, and possibly after execution of the appropriate functions by the affected computer system is confirmed, allowing normal processing of subsequent data from the affected computer system to resume.

Following the determination made during the disposition phase 703 the target container is loaded into either the recognition queue 704a or the control queue 704b in the example shown. The recognition queue 704a or the control queues 704b store target containers until the recognition process 705b or control process 707b becomes available within the AI processing sub-system 701 in the AI-RCS pipeline 700.

The queue 704a-b may be used to update the processing state 703c, to cause an input from a particular computer system to be ignored or delayed if a target container from that computer system is already located and waiting for processing within a queue for example. Following the appropriate processing of the target container, the processing state 703c may be cleared to again allow further input from the computer system. Such modification of the processing state 703c may be useful, for example, to manage or prevent backlogs and/or overruns of the AI-RCS by allowing the AI-RCS to serially process one target container from each computer system at a time. Multiple engines or pipelines may be provided in some embodiments to enable parallel processing of multiple target containers at any time.

In an embodiment, the queues 704a, 704b are scanned to extract higher-priority target containers before extracting lower-priority target containers.

In another embodiment, a separate queue is created for each priority level. For instance, three queues may be created, including one for each of low, medium, and high priority target containers. In this instance, the high priority queue may be emptied prior to the medium priority queue, and subsequently the medium priority queue is emptied prior to extracting and handling the target containers within the low priority queue. Multiple recognition queues 704a and/or multiple control queues 704b may be provided.

The queues 704a-b in effect decouple the acquisition phase 702 and the disposition phase 703 from the remainder of the example AI-RCS pipeline 700. These queues 704a-b may also provide a load balancing mechanism, wherein AI engines in a resource pool 706a are deployable when needed to service either or both of the queues as queue occupancy and thus processing loads change between recognition and control.

A target container in the recognition queue 704a enters the recognition phase 705. FIG. 7B is a diagram that includes part of the example AI-RCS pipeline of FIG. 7A, with particular focus on the recognition phase 705 and associated processes. In the recognition phase 705, the metadata within the target container is parsed or otherwise processed to determine the recognition dataset(s) 706b to be used in the evaluation of audio/video contents of the target container. The AI-RCS then invokes one or several recognition processes 705b to analyze the audio/video contents, and information indicative of results of the recognition process(es) are added to the target container metadata as shown at 705a. The target container is passed along to the events phase 709 following the completion of the recognition process(es) 705b.

In one embodiment, a recognition manager monitors the contents of the recognition queue 704a, maintaining awareness of the number of AI engines 706a available for recognition processing at 705b. When a recognition queue 704a contains one or more target containers and an AI engine 706a is available, the recognition manager selects a specific recognition dataset 706b based on metadata in a target container that is stored in the recognition queue 704a, allocates one of the AI engines from the resource pool 706a, and starts a recognition process 705b.

In such an embodiment, AI-RCS load balancing may be performed, using a fixed number of AI engines 706a allocated to recognition operations for example. Suppose there are five AI engines available for recognition processes and seven target containers are stored in the recognition queue 704a. In this case, the first five target containers are processed and the remaining two are delayed in the recognition queue 704a until one or more of the AI engines complete their current recognition processing and again become available.

Additional AI engine resources may be added to an AI-RCS in some embodiments, to increase the size of the resource pool 706a and accelerate AI-RCS processing speeds. Resources may be added to accommodate the number of computer systems on a KVM system, for example. The addition of AI engine resources may enable scaling from dozens to thousands of monitored computer systems.

In some embodiments, processing metrics of the AI-RCS may be used to dynamically adapt the AI engine resource pool 706a to improve or even optimize processing.

In another embodiment, an AI engine in the resource pool 706a may be directly coupled to or associated with a specific recognition dataset 706b. This coupling may be mandated by the AI-RCS system architecture, implemented during the AI-RCS system construction, or various recognition datasets 706b may be permanently loaded into specific AI engines in the resource pool 706a. In such an embodiment, the recognition manager, or more generally recognition processing associated with a specific recognition dataset, waits for a specific AI engine containing the specific recognition dataset to become available for processing of a target container.

Following the completion of all recognition processes 705b specified within a target container's metadata, the target container is loaded into an event queue at 708 for entry into the event phase 709.

FIG. 7C is a diagram that includes part of the example AI-RCS pipeline of FIG. 7A, with particular focus on the control phase 707 and associated processes. In the control phase 707, the AI-RCS becomes capable of automatically handling events detected during the recognition phase 705, by operating monitored computer systems for example.

In some embodiments, the control of a specific computer system may be assigned priority over all other AI-RCS operations. In such cases, the processing state 703d may be set in the disposition phase 703 to instruct the disposition engine 703c to ignore other target container inputs, so that data from only the specific computer system that is being controlled proceeds through the AI-RCS pipeline 700.

In other embodiments, the processing state 703d is set to instruct handling of input from one or more particular computer systems within the control phase 707 and handling of input from other computer systems within the recognition phase 705.

While a computer system is being controlled by the AI-RCS, an AI engine in the resource pool 706a uses one or more control datasets 706c, possibly in conjunction with one or more recognition processes 705b, to analyze the actions of the computer system and/or the effects of controlling the computer system while the computer system is being controlled. This enables the AI-RCS to keep “listening to” and “viewing” the computer system using the recognition dataset(s), while the AI-RCS is also operating the computer system using the control dataset(s).

There are several possible realizations of control datasets 706c, which each use specific methods to generate control events, for example. Example realizations of control datasets 706c include, but are not in any way limited to, those described below.

One example of a control dataset is a dataset containing a list of locations or positions, such as two-coordinate XY positions on a screen, for each of one or more GUI widgets or control elements. For example, in such a control dataset, a button may be clicked through the generation of events to first move a mouse cursor to specified XY coordinates and to then click the left mouse button.

A control dataset may be trained to locate a control element such as a button that contains specific text. For example, the AI-RCS may utilize the recognition phase 705 to locate a specifically labeled button on a display screen and then subsequently generate events to position the mouse cursor at the determined button location and to then click the left mouse button.

Events recognized on one computer system can cause control operations on another computer system. For example, one computer system may monitor the flow of water through a pipeline while another controls the flow of water. In the case where the monitoring computer system detects too high a flow rate, the AI-RCS may implement a control dataset 706c to issue events instructing the control computer system to reduce the water flow.

In a secure environment example, a recognition dataset could be used to look for classified documents that are opened on an unclassified computer system, or on a computer system in a location that should not have access to such documents. When either of these situations is recognized, the AI-RCS may generate a control dataset to send events to the computer system containing the detected document(s) to shut down or log the user off.

Once the event that initially caused a computer system to be placed under control has been resolved, the AI-RCS processing state 703d for the computer system may be cleared or set to “recognize”, for example, to allow monitoring activities to resume. For example, a pop-up dialog may have appeared to warn a user that the computer system was running low on disk space and the control dataset 706c responded by generating events to delete files within the computer system's garbage bin. At this point, the cause for control seizure by the AI-RCS has been cleared or resolved, and the AI-RCS may resume monitoring the computer system.

A target container that has passed through the recognition phase 705 and the control phase 707 is loaded into the event queue at 708. The event queue decouples the AI processing subsystem 701 from the event phase 709, such that processing results from the control phase 707 may be stored and AI engines from the resource pool 706a may be made available for processing other target containers in the recognition queue 704a or the control queue 704b before one or more events related to the control processes 707b are generated during the event phase 709.

Target containers within the event queue at 708 enter the event phase 709, wherein the target containers are examined to determine which, if any, events are to be triggered.

A set 709a of one or more event rules, provided by an AI-RCS operator or otherwise, specifies such information as types of events, event sequence, event dependencies, and behaviors that are to be taken into account for event processing 709b. In some embodiments, event rules are used by an AI-RCS operator to control the event(s) to be triggered and the conditions under which the event(s) are to be triggered.

Any of various types of events may be triggered within the event phase 709. Events may include, but are by no means limited to:

sending an email, a text message, and/or another type of communication, to one or more individuals and/or groups;

storing a copy of a digital media file, such as a video image, audio clip, or a movie, to be archived for subsequent analysis;

attaching a digital media file to a communication;

playing an audio cue to alert an AI-RCS operator of an event occurrence;

displaying the output of a source computer system on an operator computer system or other remote display or recording device—this is possible because the metadata in a target container has information about the source of data that is associated with an event;

with information about a source of data available in a target container, and appropriate privileges and authentication in some embodiments, one or more events may be generated to break the connection with a user station or computer resource, log out a user, and/or or route the user station or computer resource station to a supervisors' station for mitigation;

creating a log entry to be generated and stored for subsequent review.

The event phase 709 may also or instead trigger any of several conditional events that use the results of AI processing, stored in the metadata of a target container, to determine whether a particular event is to be triggered.

Examples of such conditional event triggering may include, but are not limited to, the following:

logging an event if an error or warning message is displayed AND the monitored computer system has no other classification; or logging the event AND sending emails to one or more supervisors if the computer system is also assigned to a group such as Finance or HR departments;

logging an event AND sending an email to the user of a computer system with a notice of use violation AND sending copies of the email to the user's supervisor AND HR if content that was detected from a user's computer system violates policy;

sending a command to block both audio and video until offending audio has passed AND storing a copy of the offending audio/video file on a server AND sending an email to legal and executive management with information about a potential violation AND including links to the stored files if a live video stream is being watched AND a word that potentially violates regulations is heard.

returning a copy of a result of a submission via a batch/API method to a user through the API AND logging the result if the audio/video content was submitted via the said batch/API method.

The processing state 703d of the AI-RCS may be changed by at least some events. For example, an event may be used to switch the AI-RCS from “recognition” mode to “control” mode. A recognition process 705b, which monitors the audio/video data entering the AI-RCS, may recognize a situation that the AI-RCS is able to resolve and thus switch into “control” mode to do so. Other types of event-based processing state or mode switching are also possible.

As described herein, during the events phase 709, target containers that have been processed are analyzed and any applicable events are triggered based on one or more event rules 709a. In some embodiments, the actual operation of events involves utilization of one or more event interfaces 709c. Event interfaces may include one or more interfaces that are unique to KVM systems and related components, although in other embodiments more generic interfaces that are not specific to KVM implementations are used.

Two primary event interface types are used in some embodiments. These include external interfaces and internal interfaces. External interfaces are interfaces that enable connections to external components or equipment that are not part of a KVM system. Some illustrative and non-limiting examples of external event interfaces are described below.

Audible signals that are emitted from the AI-RCS are examples of events. Such audible signals may include simple alert tones. More complex types of audible signals may be used to indicate the importance of events; for example, the audio tone may be a claxon heard on a naval ship during emergencies. Audible signals may also or instead include recorded and/or computer-generated speech in any of a variety of languages.

Interfaces such as serial interfaces may be used to control any of various types of external systems. Examples of such interfaces include legacy RS-232 and RS-422 serial communications interfaces. Machine control interfaces, such as those used in broadcast and manufacturing facilities, which can include relay contact closures and/or other general purpose I/O, may also or instead be used in some embodiments.

Ethernet interfaces can also or instead be employed to communicate with other computer systems across a computer network. In these cases, the AI-RCS may connect to an external system based on one or more event rules, and transmit data, audio and/or video files, video frames, and/or other types of data available to the AI-RCS.

USB interfaces may be used to connect to any of a variety of computer systems. USB interfaces may be used to send or receive data, store files, and/or control external computer systems through the emulation of mouse and keyboard operations for example.

Internal event interfaces may also or instead be used for events. Internal interfaces may be used to alter the state of the KVM system and/or to control computers attached to the KVM system, for example. In one illustrative embodiment, an AI engine in the resource pool 706a uses a control dataset 706c to simulate a human operator, sending keyboard and mouse data to a computer on the KVM system. A resulting event is internally routed using information within the metadata and delivered to a computer system across the KVM system.

In such an embodiment, the internal events may be used to simulate the operation of a mouse through the use of motion and position data. The events may issue mouse clicks and/or mouse wheel operation.

In another embodiment, internal events may be used to simulate the operation of a keyboard, by in effect issuing at least key down events, and possibly key up events as well.

Various embodiments are described in detail above. More generally, embodiments may include any of various disclosed features in any of various combinations.

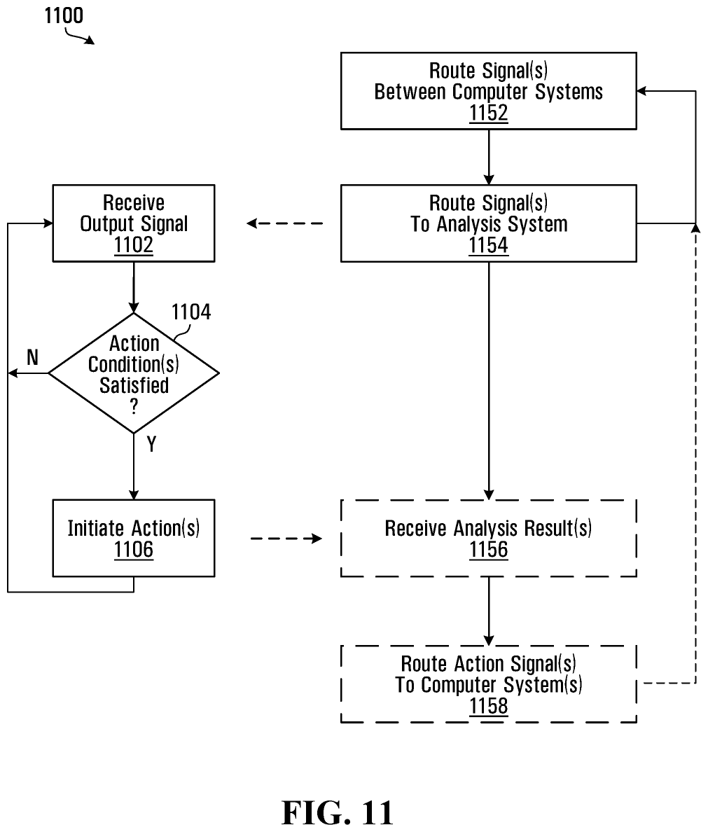

FIG. 11 is a flow diagram illustrating an example method according to an embodiment. The example method 1100 includes a set of operations 1102, 1104, 1106 and a set of operations 1152, 1154, 1156, 1158, which may be performed by different components or systems. Each of these sets of operations may be implemented independently of the other, and are shown together in FIG. 11 only to illustrate how operations that may be separately implemented can be coordinated or otherwise related.

Considering the operations at the left-hand side of FIG. 11, in some embodiments a method involves receiving an output signal at 1102. This output signal is received by a first (monitoring) computer system, such as an AI-RCS, and is indicative of one or both of a display signal and an audio signal currently being provided as output by a second (monitored) computer system, such as a computer resource or station. This second computer system may, but need not necessarily, be part of a KVM system. As shown by way of example in FIGS. 5 and 6, an AI-RCS need not be implemented only in KVM systems.

FIG. 11 also includes, at 1104, an operation of determining, by the first computer system, whether the output signal received at 1102 satisfies one or more conditions for performing one or more actions. As disclosed elsewhere herein by way of example, this type of determination may involve making a determination based on a set of one or more rules in some embodiments.

An output signal may or may not satisfy the condition(s) for taking any action. If no action is in order, then processing returns to 1102 in the example shown. A next output signal received at 1102 may be from the same computer system or from a different computer system in a monitoring sequence, for example.

Responsive to determining at 1104 that a received output signal satisfies one or more action condition(s), then the example method 1100 proceeds at 1106, with the first computer system initiating the action, or each action if multiple actions are to be initiated. An action may include, for example, one or more of: blocking a control signal that is intended to control the second computer system; blocking an operation of the second computer system;

and aborting an operation of the second computer system. Another example of an action is providing a control signal to the second computer system.

An action may also or instead involve generating an alert. The alert may be or include, for example, an alert to one or more of: the first computer system, the second computer system, another computer system, and an alert device. Other examples of alerts are also disclosed herein.

Multiple actions may be initiated at 1106, such as providing a control signal to the second computer system and also blocking a further control signal that is intended to control the second computer system. The further control signal may be or include, for example, a control signal that is generated by the second computer system, and/or a control signal that is generated by another computer system by which the second computer system is controllable. In this latter example, a computer resource might be monitored by an AI-RCS, and also be controllable by a user station. Within this context, the AI-RCS may provide a control signal to the computer resource and block a further control signal from the user station.

Other examples of actions are also provided elsewhere herein.

It should be noted that initiating action(s) at 1106 may include a monitoring computer system performing one or more actions and/or causing one or more other systems or components to perform one or more actions. For example, in one embodiment a monitoring computer system may itself generate and provide a control signal to a monitored computer system, but cause a separate alert device to actually generate an alert. The actions in this example include providing a control signal to the monitored computer system, which is performed by the monitoring computer system, and generating an alert, which the monitoring computer system causes the alert device to perform. These are non-limiting examples of operations encompassed at 1106 in FIG. 11.

As noted elsewhere herein, embodiments may, but need not necessarily, be implemented in a KVM system. In a KVM embodiment, the monitored second computer system is part of a KVM system, and in such an embodiment the receiving at 1102 may involve receiving the output signal from a management component of the KVM system, such as a KVM manager.

This is just one illustrative embodiment. Even in a KVM system, an AI-RCS need not necessarily receive signals for analysis only from a KVM manager. In FIG. 3, for example, the AI-RCS 302 may receive signals from the managed network switch 303.

As a further example, the monitored second computer system may be or include a virtual machine. Embodiments disclosed herein are not limited only to physical computer systems. One physical computer system can host multiple virtual machines, for example. Consider a large corporation, with no KVM matrix, and implementation of an AI-RCS in a corporate network on which virtual machines (VMs) are hosted. One or more AI-RCS interfaces and VM protocols, for example, enable the AI-RCS to receive copies of the VM display signals across the corporate network, and this in turn enables the AI-RCS to monitor and control the VMs based on the VM display signals and what it “sees” from the VMs.

The return arrow from 1106 to 1102 in FIG. 11 illustrates that monitoring may be an ongoing process, even when one or more actions are initiated at 1106.

Turning now to the right-hand side of FIG. 11, in some embodiments a method involves routing one or more output signals between a first (monitoring) computer system and a second (monitored) computer system at 1152. Each output signal is indicative of one or both of a display signal and an audio signal currently being provided as output by the second computer system. Further routing of the output signal(s) to an analysis system is shown at 1154. Output signal routing to the analysis system is for determination as to whether each output signal satisfies one or more condition(s) for performing one or more actions, as shown by way of example at 1104, and initiation of the action(s) responsive to a determination that the output signal satisfies the condition(s), as shown by way of example at 1106.

These operations in FIG. 11 may be performed, for example, by a KVM manager in a KVM system, and/or by a switch or router in a KVM system or a non-KVM system. An AI-RCS may also or instead be involved in such routing, to the extent that the AI-RCS may interact with a KVM manager and/or a network switch or router to request output signals associated with monitored computer systems or otherwise configure or control routing to obtain output signals for analysis.

One or more analysis results may also be received at 1156. For example, a signal associated with initiating an action may be received from the analysis system. As shown at 1158, one or more received signals associated with initiating the action(s) may be routed to one or both of the first (monitoring) computer system and the second (monitored) computer system, and/or elsewhere in some embodiments.

The return arrows from 1154, 1158 to 1152 are intended to indicate that signal routing may be ongoing. In some embodiments, a method involves routing signals for analysis at 1154, and a routing component is not otherwise involved in a monitoring/control process. Other embodiments include additional operations such as those shown at 1156, 1158. The return arrow from 1158 to 1152 is shown as a dashed line to indicate that further signal routing need not be delayed until analysis of previously routed signals is complete.

FIG. 11 is an illustrative example of a method according to an embodiment. Other embodiments may include fewer, additional, and/or different operations, performed in a similar order or a different order than shown. Examples of how each operation may be performed, and examples of other operations that may be performed in some embodiments, are disclosed elsewhere herein. Further variations in methods may also or instead be or become apparent to those skilled in the art.

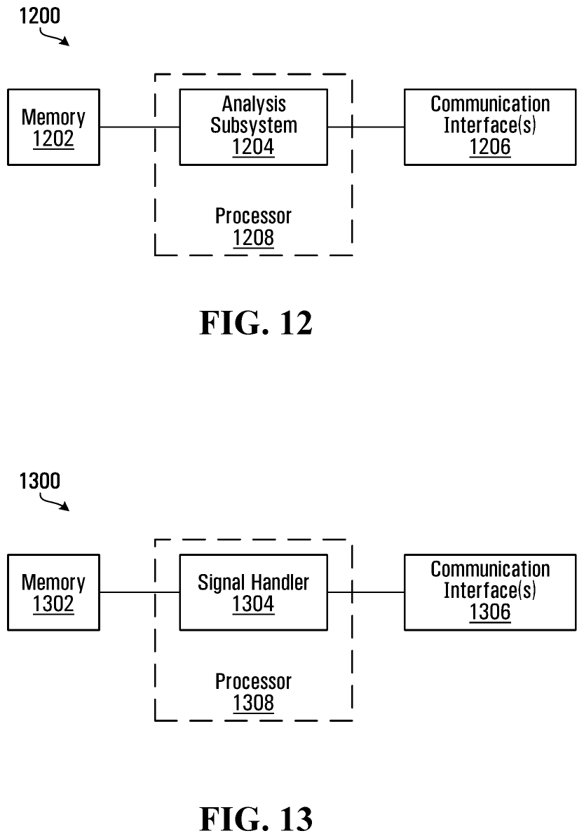

Apparatus embodiments are also possible. FIG. 12, for example, is a block diagram illustrating an apparatus according to another embodiment. The example apparatus 1200 includes a memory 1202, an analysis subsystem 1204, and one or more communication interfaces 1206, and is illustrative of one possible implementation of an AI-RCS.

The memory 1202 includes one or more physical memory devices. Solid-state memory devices such as a Flash memory device, and/or memory devices with movable or even removable storage media, could be implemented. In an embodiment, the memory 1202 is a dedicated memory device for storing software and/or data related to signal analysis and computer system monitoring/control. In other embodiments the memory 1202 is implemented as addresses or locations in memory that is also used for other purposes. Those skilled in the art will be familiar with various types of memory devices that may be provided at 1202.

A processor as shown at 1208 represents one example implementation of the analysis subsystem 1204. More generally, the analysis subsystem 1204 may be implemented using hardware, firmware, one or more components that execute software, or a combination thereof. Examples of such implementations are provided elsewhere herein.

Examples of communication interfaces that may be provided in an AI-RCS at 1206 are also provided elsewhere herein.

The example apparatus 1200 is illustrative of an embodiment in which an analysis subsystem 1204 is coupled to a communication interface 1206, to receive through the communication interface an output signal that is indicative of one or both of a display signal and an audio signal currently being provided as output by a computer system. The analysis subsystem 1204 is configured, by executing software in some embodiments, to determine whether the output signal satisfies one or more conditions for performing one or more actions, and to initiate the action(s) responsive to determining that the output signal satisfies the condition.

For example, the analysis subsystem may be configured to determine, based on a set of one or more rules, whether the output signal satisfies the condition(s) for performing the action(s).

Examples of actions, initiating actions, and monitored computer systems including virtual machines, are provided above with reference to FIG. 11, and elsewhere herein.

The example apparatus 1200 may be implemented in a KVM system, to monitor a computer system that is part of the KVM system. In a KVM embodiment, one or more communication interfaces at 1206 may enable communication between the apparatus 1200 and a management component of the KVM system, such as a KVM manager, and the analysis subsystem 1204 is coupled to receive an output signal for analysis from the management component. This is only one embodiment. Other embodiments, including KVM embodiments and non-KVM embodiments, in which the analysis subsystem 1204 is to receive signals for analysis from one or more other components such as an AI-RCS interface or a switch or router, for example, are also possible.

FIG. 13 is a block diagram illustrating an apparatus according to a further embodiment. The example apparatus 1300 includes a memory 1302, a signal handler 1304, and one or more communication interfaces 1306, and is illustrative of one possible implementation of components such as an RX unit, a TX unit, an AI-RCS interface, a KVM manager, and a network switch or router.

The memory 1302, like the memory 1202, includes one or more physical memory devices. The examples provided for memory 1202 above also apply to the memory 1302.

The signal handler 1304 may be implemented using hardware, firmware, one or more components that execute software, or a combination thereof. Examples of such implementations are provided elsewhere herein. The processor shown at 1308 is one example implementation of the signal handler 1304.

Examples of communication interfaces that may be provided at 1306 are also provided elsewhere herein.

In an embodiment, the signal handler 1304 is coupled to a communication interface at 1306 to route, between a first (monitoring) computer system and a second (monitored) computer system, an output signal indicative of one or both of a display signal and an audio signal currently being provided as output by the second computer system. The signal handler is further configured, by executing software for example, to also route the output signal to an analysis system for determination as to whether the output signal satisfies one or more conditions for performing one or more actions and initiation of the action(s) responsive to a determination that the output signal satisfies the condition(s).

Any of various features disclosed elsewhere herein may be implemented in apparatus embodiments such as those shown in FIGS. 12 and 13 and described above, and/or otherwise disclosed herein. In general, apparatus embodiments may include fewer, additional, and/or different components, coupled together in a similar manner or differently than shown by way of example in the drawings. For example, apparatus components may be configured to perform or enable any of various operations that are disclosed herein, in any of various combinations.

Such features may also or instead be provided in other embodiments. For example, a non-transitory processor-readable medium may be used to store instructions which, when executed by a processor, cause the processor to perform a method. In an embodiment, the processor is a processor in a first computer system, and the instructions cause the processor to perform a method that involves receiving, by the first computer system, an output signal indicative of one or both of a display signal and an audio signal currently being provided as output by a second computer system; determining, by the first computer system, whether the output signal satisfies one or more conditions for performing one or more actions; and initiating the action(s), by the first computer system and responsive to determining that the output signal satisfies the condition(s).

According to another embodiment, the instructions cause the processor to perform a method that involves routing, between a first computer system and a second computer system, an output signal indicative of one or both of a display signal and an audio signal currently being provided as output by the second computer system; and further routing the output signal to an analysis system for determination as to whether the output signal satisfies one or more conditions for performing one or more actions and initiation of the action(s) responsive to a determination that the output signal satisfies the condition(s).

Features disclosed elsewhere herein may be implemented in embodiments relating to a non-transitory processor-readable medium. For example, stored instructions, when executed, may cause a processor to perform or enable any of various operations that are disclosed herein, in any of various combinations.

Embodiments consistent with the present disclosure may be useful in making integration of AI into large computer networks more feasible. For example, in a KVM system, a single tensor acceleration card in an AI-RCS may be used to augment many computers with AI capabilities. As well, the use of the AI-enabled KVM, or an AI-RCS interface without a KVM system, may allow legacy computers to be augmented with AI where it may not be possible to directly insert a tensor acceleration card or other AI component due to power or space constraints.

Advantageously, AI augmentation in a KVM system, or in other types of systems that are not KVM systems, may involve only an initial investment in an AI-RCS that allows for the continuing use of existing legacy computers and software applications. In some embodiments, AI augmentation is in the form of hosted AI-RCS resources, in a cloud-based implementation for example, that enables non-owned resources to be accessed on a per-use or subscription basis without the expense of actually implementing AI resources.

Implementation of AI across a KVM network may be particularly advantageous in enabling the automation of monitoring tasks and possibly even control tasks by an AI-RCS, allowing human operators to focus on higher level tasks.

Implementation of AI does not necessarily preclude human intervention. For example, a human operator may still be able to take control of computer resources and/or user stations by operating an input device such as a keyboard or mouse at a user station for example. Following the completion of the human intervention, the AI-RCS may resume monitoring and control tasks.

An AI-enabled KVM system and related methods of monitoring and controlling computers across a KVM network may be used in any of several applications as recognition datasets are developed. An AI-RCS may apply different rule sets to different categories of computer systems connected on the KVM system, for example, to specify conditions that are to be recognized and any events to be generated when certain conditions arise. When coupled with a KVM system, an AI-RCS system may monitor any of the KVM computer systems for individual, group, or systemic issues, including warning messages or dialogs; error messages or dialogs; improper use, illegal use, and/or policy violations by users of the computer systems; etc. Many applications, in KVM and non-KVM systems, are possible.

Some applications are described below. These example or sample applications, however, are not intended to provide an exhaustive list.

A sample application may include a recognition dataset capable of detecting specific words or phrases within an audio stream. In an embodiment, AI augmentation may be used to help avoid a live broadcast incurring fines for regulation violations through the detection and selective muting of unacceptable audio by an AI-RCS.

A more complex embodiment of this sample application may use an AI-RCS to analyze a corresponding video stream and determine the speaker of the unacceptable audio in real-time. The AI-RCS may produce events to mute or obscure the unacceptable audio and to blur the mouth of the speaker for the duration of such audio.

For audio-based recognition, separate recognition datasets could be created for each of multiple languages of interest, or all such languages could be merged into a master recognition dataset that covers multiple languages.

Another possible AI-RCS application is to enforce workforce policies prohibiting the access or display of objectionable content on computer systems. The AI-RCS may monitor computer systems and, if objectionable content is detected, may notify a user of policy violation, email the user's manager and HR, and/or blank the display that is being used by a user to display the content. These actions can all be taken without human intervention.

A further possible area of interest may be the development of an AI-operated television studio, wherein the AI-RCS uses a recognition dataset to locate faces of on-air talent and use their on-screen location to generate events to manipulate the position, movement and/or focus of robotic cameras. An example of such an application is the use of automated robotic cameras framing a news anchor and green screen during a weather report.

Another application involving broadcast may be the examination of streaming content for inclusion in programming. An AI-RCS may be trained to control a video sever to automatically perform quality assurance checks on several video clips from the Internet. These checks may include generation of a set of keywords to aid in future clip searches, and/or flagging of clips for human review, for assessment of copyright, usage rights, and/or other legal issues.

In an embodiment, an AI-enabled KVM system is used to simultaneously analyze multiple streams from several video sources. For example, the streams may be analyzed for frozen video during satellite ingest. Such analysis could also or instead be applied to live events such as sporting events, to scan video of a crowd for rude gestures, for example. Video sources containing such gestures may be flagged as unsafe and be blocked prior to airing.

Some embodiments may also or instead help improve video quality. Based on monitoring of video sources, parameters such as video levels and/or color correction for several live video streams may be adjusted or otherwise controlled in parallel.

Applications are not in any way restricted to video production. An AI-enabled KVM system, or non-KVM system, may be used to monitor and prevent improper or illegal activities within financial institutions. For instance, an AI-RCS within a bank's network may flag an improper money transfer, send emails of screenshots of the transfer, and/or send an alert to a security team.

Such a system may also or instead be used to control confidential or classified documents within military, intelligence and government organizations for example. An AI-RCS may be trained to monitor a network to detect access or even attempted access to confidential or classified documents on network computers, including instances where a computer system has been disconnected from the network. Alerts to the network may be triggered if the computer system that has been used in attempting to accessing or attempting to access such documents has intentionally been disconnected.

The system may also or instead be used to retrofit legacy computers with AI-RCS interfaces, within a manufacturing line or facility or other systems with a large number of legacy components for example, allowing the AI-RCS to control and/or otherwise aid in manufacturing and/or other processes for which AI augmentation might not otherwise be cost-effective.

Another sample application within the manufacturing industry is an AI-RCS that is trained to automate manufacturing tasks. Although certain tasks such as high-level initialization tasks may involve intervention by a human operator, many tasks may potentially be automated. For example, a human operator may move a mouse cursor into a designated area within a display to indicate completion of high-level tasks, and to trigger remaining tasks to be executed by the AI-RCS. This type of implementation may still allow the human operator to resume control over the computer at any time if necessary, by moving the mouse cursor from the designated area in the display, which would be detected by the AI-RCS during monitoring of the display.

AI augmentation may also or instead be used to prevent a user from inadvertently destroying computer resources and/or provide an alert on detection of an action that will destroy or adversely impact such resources. For instance, the AI-RCS may change directories or interrupt the flow of control data to prevent the accidental reformatting of a ‘C’ drive when it is assumed that the user is intending on formatting a USB drive on ‘E’.

An AI-RCS may also or instead be used to mitigate critical errors involving multiple computers. An example of this type of application relates to a first computer system in a KVM system in an oil refinery monitoring the transfer of crude oil into a holding tank and a second computer on the system controlling transfer pumps. The AI-RCS may detect an error within the monitoring applications on the first computer system, such as a full tank or a plugged pipe, and subsequently use the second computer system to shut down further transfers.

Numerous modifications and variations of the present disclosure are possible in light of the above teachings. It is therefore to be understood that within the scope of the appended claims, the disclosure may be practiced otherwise than as specifically described herein.

The divisions of functions represented in the drawings, for example, are solely for illustrative purposes. Other embodiments could include fewer, more, and/or different components than explicitly shown, interconnected in the same or a different order. Methods could similarly include fewer, more, and/or different operations performed in a similar or different manner than explicitly described herein.

As an example, several drawings illustrate single-head (single monitor) computing resources and user stations. An AI-RCS can also or instead work with dual-head, quad-head, etc. computing implementations and embodiments.

Several drawings also illustrate separate physical computer systems. An AI-RCS and/or a KVM system can also or instead interface to one or more virtual machine systems. In an embodiment, a TX unit does not interface directly to a physical computer system, but instead utilizes a physical network connection to interface to any of several virtual machines hosted on a physical server. One physical server can host dozens of virtual machines. In such an embodiment, monitoring and/or control of a virtual machine can be identical to that of a physical machine, but the AI-RCS may utilize standardized network protocols to communicate with, monitor and control the virtual machine, via the TX unit in this example, on the physical host server.

In addition, although described primarily in the context of apparatus and methods, other implementations are also contemplated, as instructions stored on a non-transitory processor-readable medium, for example.

What is claimed is:

1. A method comprising:
receiving, by a first computer system, an output signal indicative of one or both of a display signal and an audio signal currently being provided as output by a second computer system;
determining, by the first computer system, whether the output signal satisfies a condition for performing an action;
initiating, by the first computer system and responsive to determining that the output signal satisfies the condition, the action.

2. The method of claim 1, wherein the determining comprises determining, based on a set of one or more rules, whether the output signal satisfies a condition for performing an action.

3. The method of claim 1, wherein the action comprises one or more of:
blocking a control signal that is intended to control the second computer system;
blocking an operation of the second computer system;
aborting an operation of the second computer system.

4. The method of claim 1, wherein the action comprises providing a control signal to the second computer system.

5. The method of claim 4, wherein the action further comprises:
blocking a further control signal that is intended to control the second computer system.

6. The method of claim 5, wherein the further control signal comprises a control signal generated by the second computer system.

7. The method of claim 5, wherein the further control signal comprises a control signal generated by a third computer system by which the second computer system is controllable.

8. The method of claim 1, wherein the action comprises generating an alert.

9. The method of claim 8, wherein the alert comprises an alert to one or more of:
the first computer system, the second computer system, a further computer system, and an alert device.

10. The method of claim 1, wherein the second computer system comprises part of a Keyboard/Video/Mouse (KVM) system.

11. The method of claim 10, wherein the receiving comprises receiving the output signal from a management component of the KVM system.

12. The method of claim 1, wherein the second computer system comprises a virtual machine.

13. An apparatus comprising:
a communication interface;
an analysis subsystem, coupled to the communication interface, to receive through the communication interface an output signal indicative of one or both of a display signal and an audio signal currently being provided as output by a computer system, to determine whether the output signal satisfies a condition for performing an action, and to initiate the action responsive to determining that the output signal satisfies the condition.

14. The apparatus of claim 13, wherein the analysis subsystem is to determine, based on a set of one or more rules, whether the output signal satisfies a condition for performing an action.

15. The apparatus of claim 13, wherein the action comprises one or more of:
blocking a control signal that is intended to control the computer system;
blocking an operation of the computer system;
aborting an operation of the computer system.

16. The apparatus of claim 13, wherein the action comprises providing a control signal to the computer system.

17. The apparatus of claim 16, wherein the action further comprises:
blocking a further control signal that is intended to control the computer system.

18. The apparatus of claim 17, wherein the further control signal comprises a control signal generated by the computer system.

19. The apparatus of claim 17, wherein the further control signal comprises a control signal generated by a further computer system by which the computer system is controllable.

20. The apparatus of claim 13, wherein the action comprises generating an alert.

21. The apparatus of claim 13, wherein the alert comprises an alert to one or more of: the apparatus, the computer system, a further computer system, and an alert device.

22. The apparatus of claim 13, wherein the computer system comprises part of a Keyboard/Video/Mouse (KVM) system.

23. The apparatus of claim 22, wherein the communication interface enables communication between the apparatus and a management component of the KVM system, wherein the analysis subsystem is coupled to the communication interface to receive the output signal from the management component.

24. The apparatus of claim 13, wherein the computer system comprises a virtual machine.

25. A non-transitory processor-readable medium storing instructions which, when executed by a processor in a first computer system cause the processor to perform a method, the method comprising:
receiving, by the first computer system, an output signal indicative of one or both of a display signal and an audio signal currently being provided as output by a second computer system;
determining, by the first computer system, whether the output signal satisfies a condition for performing an action;
initiating, by the first computer system and responsive to determining that the output signal satisfies the condition, the action.

26. A method comprising:
routing, between a first computer system and a second computer system, an output signal indicative of one or both of a display signal and an audio signal currently being provided as output by the second computer system;
further routing the output signal to an analysis system for determination as to whether the output signal satisfies a condition for performing an action and initiation of the action responsive to a determination that the output signal satisfies the condition.

27. The method of claim 26, further comprising:
receiving from the analysis system a signal associated with initiating the action;
routing the signal associated with initiating the action to one or both of the first computer system and the second computer system.

28. An apparatus comprising:
a communication interface;
a signal handler, coupled to the communication interface, to route, between a first computer system and a second computer system, an output signal indicative of one or both of a display signal and an audio signal currently being provided as output by the second computer system, and to further route the output signal to an analysis system for determination as to whether the output signal satisfies a condition for performing an action and initiation of the action responsive to a determination that the output signal satisfies the condition.

29. A non-transitory processor-readable medium storing instructions which, when executed by a processor cause the processor to perform a method, the method comprising:
routing, between a first computer system and a second computer system, an output signal indicative of one or both of a display signal and an audio signal currently being provided as output by the second computer system;
further routing the output signal to an analysis system for determination as to whether the output signal satisfies a condition for performing an action and initiation of the action responsive to a determination that the output signal satisfies the condition.
